(19) United States
(12) Patent Application Publication
(10) Pub. No.: US 2026/0149040 A1
(43) Pub. Date: May 28, 2026

(54) SOLID POLYMER ELECTROLYTE AND A RECHARGEABLE BATTERY COMPRISING THE SOLID POLYMER ELECTROLYTE

(71) Applicant: Hong Kong Centre for Cerebro-Cardiovascular Health Engineering Limited, Pak Shek Kok (HK)

(72) Inventors: Chunyi Zhi, Pak Shek Kok (HK); Dechao Zhang, Pak Shek Kok (HK)

(21) Appl. No.: 19/395,342

(22) Filed: Nov. 20, 2025

Related U.S. Application Data
(60) Provisional application No. 63/724,470, filed on Nov. 25, 2024.

(51) Int. Cl. H01M 10/0565; H01M 10/0525; H01M 10/42

(52) U.S. Cl. CPC H01M 10/0565; H01M 10/0525; H01M 10/4235; H01M 2300/0034

(57) ABSTRACT

A solid polymer electrolyte and a rechargeable battery includes the solid polymer electrolyte. The solid polymer electrolyte includes a polymer matrix including a vinylidene fluoride (VDF)-based compound and a residual solvent including a fluorinated solvent, wherein the residual solvent is arranged facilitate ion transportation of ions of a solvation complex of a metal in the rechargeable battery.

### TECHNICAL FIELD

This invention relates to a solid polymer electrolyte and a rechargeable battery comprising the solid polymer electrolyte. Particularly, although not exclusively, the invention relates to vinylidene fluoride-based polymer electrolytes for use in lithium solid battery.

### BACKGROUND OF THE INVENTION

Metallic lithium may be used as anode material for high-energy-density batteries owing to its exceptional merits, including a low negative potential (−3.04 V vs. standard hydrogen electrode) and a high theoretical specific capacity (3860 mAh g⁻¹). Despite these notable advantages, the practical application of lithium metal anode in conjunction with organic liquid electrolytes faces numerous challenges, such as the uncontrolled growth of lithium dendrites, poor cycle ability and durability, and the inherent risks of fire and explosions associated with the use of organic electrolytes.

Preferably, nonflammable solid-state electrolytes may be used to replace liquid electrolytes. Among various solid electrolytes, solid polymer electrolytes (SPEs) is preferred due to their high flexibility, interfacial compatibility, facile processability, and cost-effectiveness. In particular, the inventors devised that vinylidene fluoride (VDF)-based polyvinylidene difluoride (PVDF) and its derivative poly(vinylidene fluoride-co-hexafluoropropylene) (PVHF) may be included as polymer matrices for SPEs.

### SUMMARY OF THE INVENTION

In accordance with a first aspect of the present invention, there is provided a solid polymer electrolyte for a rechargeable battery, comprising a polymer matrix including a vinylidene fluoride (VDF)-based compound and a residual solvent including a fluorinated solvent, wherein the residual solvent is arranged facilitate ion transportation of ions of a solvation complex of a metal in the rechargeable battery.

In accordance with the first aspect, the fluorinated solvent has a molecular structure including a —CF₃ group.

In accordance with the first aspect, the residual solvent includes fluorinated 2,2,2-Trifluoro-N, N-dimethylacetamide (FDMA).

In accordance with the first aspect, the metal includes lithium supplied from the anode of the rechargeable battery.

In accordance with the first aspect, the rechargeable battery includes a lithium battery, and the solvation complex of the metal has a ⁺solvation structure.

In accordance with the first aspect, the residual solvent is further arranged to stabilize a solid electrolyte interface formed between an electrode material and the solid polymer electrolyte in the rechargeable battery.

In accordance with the first aspect, the solid electrolyte interface is stabilized by a protective barrier at the solid electrolyte interface.

In accordance with the first aspect, the protective barrier of the solid electrolyte interface includes a predominant component of LiF.

In accordance with the first aspect, the protective barrier is arranged to facilitate suppression of dendrite formation at the anode and/or corrosion of the anode.

In accordance with the first aspect, the polymer matrix includes poly(vinylidene fluoride-co-hexafluoropropylene) (PVHF).

In accordance with the first aspect, the —CF₃ group is arranged to improve an oxidative stability of cathode of the rechargeable battery.

In accordance with the first aspect, the —CF₃ group is arranged to reduce interactions between FDMA and PVHF polymer chains.

In accordance with the first aspect, the —CF₃ group is arranged to facilitate uniform dispersion of FDMA within PVHF and to facilitate establishment of continuous ion transport channels.

In accordance with a second aspect of the present invention, there is provided a rechargeable battery comprising: a layer of lithium arranged to operate as an anode of the rechargeable battery, a layer of lithium compound arranged to operate as a cathode of the rechargeable battery, and a polymer matrix between the anode and the cathode, the polymer matrix includes a vinylidene fluoride (VDF)-based compound and a residual solvent including a fluorinated solvent, wherein the polymer matrix is a solid polymer electrolyte, and the residual solvent is arranged facilitate ion transportation of ions of a solvation complex of lithium in the rechargeable battery.

In accordance with the second aspect, the residual solvent includes fluorinated 2,2,2-Trifluoro-N, N-dimethylacetamide (FDMA).

In accordance with the second aspect, the solvation complex of the metal has a ⁺solvation structure.

In accordance with the second aspect, the residual solvent is further arranged to stabilize by forming a protective barrier at a solid electrolyte interface formed between an electrode material and the solid polymer electrolyte in the rechargeable battery, wherein the protective barrier of the solid electrolyte interface includes a predominant component of LiF, and the protective barrier is arranged to facilitate suppression of dendrite formation at the anode and/or corrosion of the anode.

In accordance with the second aspect, the polymer matrix includes poly(vinylidene fluoride-co-hexafluoropropylene) (PVHF).

In accordance with the second aspect, the cathode includes LiFePO₄ or LiCoO₂.

In accordance with the second aspect, the layer of lithium is thinner or equal to 20 μm.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the invention will now be described, by way of example, with reference to the accompanying drawings in which:

FIG. 1A is a plot showing galvanostatic cycling profiles of Li∥PVHF-DMF-SPE∥ Li symmetrical cells at a current density of 0.3 mA cm⁻² with 450 μm and 20 μm thick Li metal anode, respectively. Insets display digital photos of the cycled Li anode, showing significant gray discoloration on the 450 μm Li anode and complete corrosion of the 20 μm Li anode.

FIG. 1B is an SEM image of a top view of the cycled 450 μm Li.

FIG. 1C is an SEM image of a cross-section view of the cycled 450 μm Li.

FIG. 1D are images showing visual observation of the reaction between Li and DMF solvent over time.

FIG. 2A is an illustration showing a comparison of HOMO and LUMO energies for FDMA, DMF, NMP, and DMSO, with inserts show electrostatic potentials (ESP) mappings.

FIG. 2B is a plot showing calculated reduction potential of FDMA, DMF, NMP, and DMSO based on density functional theory.

FIG. 2C is an illustration showing optical photographs of Li foil after different aging times in FDMA solvent and XPS spectra of the Li surfaces.

FIG. 2D is a plot showing Arrhenius plots as a function of temperature for PVHF-FDMA-SPE and PVHF-DMF-SPE.

FIG. 2E is a plot showing solvent contents in PVHF-FDMA-SPE and PVHF-DMF-SPE obtained from TGA measurements.

FIG. 2F is a plot showing Raman spectra of PVHF-FDMA-SPE and corresponding quantification results of TFSI⁻ anion states in the SPE.

FIG. 2G are snapshots of the MD simulation boxes of PVHF-FDMA-SPE.

FIG. 2H are radial distribution function (RDF) plots of Li—O (TFSI—), Li—O (FDMA), and Li—F (PVHF).

FIG. 2I is a schematic diagram of Li-FDMA-3TFSI⁻ solvation structure transportation mechanism in PVHF-FDMA-SPE.

FIG. 3A is a plot showing galvanostatic cycling profiles of the Li∥PVHF-FDMA-SPE∥Li symmetrical cells with 450 μm thick Li metal anode at 0.3 mA cm⁻² and 0.3 mAh cm⁻².

FIG. 3B is a plot showing galvanostatic cycling profiles of the Li∥PVHF-FDMA-SPE∥Li symmetrical cells with 450 μm thick Li metal anode at 0.5 mA cm⁻² and 0.5 mAh cm⁻².

FIG. 3C is a plot showing comparison of cumulative Li plating/stripping capacity of Li∥Li symmetrical cells with PVHF-FDMA-SPE and VDF-based SPEs using commonly used solvents (The colors of green, blue, wine red and orange represent DMF, NMP, DMSO, and FDMA solvents, respectively.

FIG. 3D is plot showing galvanostatic cycling profiles of the Li∥PVHF-FDMA-SPE∥Li symmetrical cells at 0.3 mA cm⁻² and 0.3 mAh cm⁻² with a 20 μm thick ultrathin Li anode.

FIG. 3E is a plot showing coulombic efficiency (CE) of the Li∥Cu cell with PVHF-FDMA-SPE, with insets displaying Li deposition-stripping profiles.

FIG. 4A is a top-view cross-sectional SEM images of Li metal electrode after 100 cycles at 0.5 mA cm⁻² (inset shows the optical photographs of cycled Li metal anode).

FIG. 4B is a cross-sectional SEM images of Li metal electrode after 100 cycles at 0.5 mA cm⁻².

FIG. 4C is an image showing morphology of the Li metal anode initially.

FIG. 4D is an image showing morphology of the Li metal anode after cycling.

FIG. 4E is a set of plots showing quantified atomic ratios of the elements in SEI and XPS depth profiles of C 1s, F 1s, and Li 1s at different XPS sputtering times of cycled Li metal electrodes.

FIG. 4F shows TOF-SIMS 3D reconstruction of the sputtered volume of C₂HO⁻, LiCO₃⁻, LiF₂⁻, LiN₃F⁻ and LiSF⁻.

FIG. 5A is a plot showing rate performance of Li∥LFP coin cells assembled with PVHF-FDMA-SPE and 450 μm Li metal anodes.

FIG. 5B is a corresponding galvanostatic charge/discharge curves of Li∥LFP coin cells assembled with PVHF-FDMA-SPE and 450 μm Li metal anodes.

FIG. 5C is a plot showing cycling stability of Li∥LFP cell at a rate of 1 C.

FIG. 5D is a plot showing comparison of cycling stability of a battery fabricated in accordance with embodiments of the present invention with other VDF-based and other SPEs-based solid state lithium metal batteries.

FIG. 5E is a plot showing cycling and rate performances for Li∥LFP coin cells with 20 μm Li metal anode.

FIG. 5F is a plot showing charge/discharge voltage profiles under different current densities for Li∥LFP coin cells with 20 μm Li metal anode.

FIG. 5G is a plot showing cycling performance of the Li∥LFP pouch cell, inset shows the optical photograph of the pouch cell with a cathode size of 5×8 cm².

FIG. 6A Is a plot showing rate performance of Li∥LCO cell with a charge cutoff voltage of 4.3 V.

FIG. 6B is a plot showing cycle performance of Li∥LCO cell at 0.5 C.

FIG. 6C is a plot showing cycling and rate performances of Li∥LCO cell in the voltage range of 2.8-4.48 V.

FIG. 6D is a plot showing corresponding charge/discharge voltage profiles under different current density.

FIG. 6E is a plot showing comparison of the voltage-capacity performances of Li∥PVHF-FDMA-SPE∥LCO cell and previously reported solid-state lithium metal batteries based on VDF-based SPEs.

FIG. 7 is a plot showing EIS of the Li∥PVHF-DMF-SPE∥Li symmetrical cell with 450 μm Li metal anode before and after cycled at 0.3 mA cm⁻².

FIG. 8 is a set of plots showing XPS profiles of C 1s, F 1s , and Li 1s spectra of the cycled Li metal anode disassembled from Li∥PVHF-DMF-SPE∥Li symmetrical cell.

FIG. 9 is a plot showing comparison of the calculated adsorption energies of FDMA, DMF, NMP, and DMSO solvent on Li (110) surface.

FIG. 10 is a set of images showing a visual observation of the reaction between Li and FDMA solvent over time a. Digital photo of the Li anode in b DMSO, c NMP solvent, and d FDMA based 1M LiTFSI electrolyte after one week.

FIG. 11 a is a top-view SEM images of PVHF-FDMA-SPE membrane.

FIG. 11B is a cross-sectional SEM images of PVHF-FDMA-SPE membrane.

FIG. 11C is a set of optical photographs of PVHF-FDMA-SPE membrane in a flat and folding state.

FIG. 12 is a plot showing stress-strain curves of PVHF-FDMA-SPE and PVHF-DMF-SPE membrane.

FIG. 13 is a plot showing comparison of the calculated binding energy between Li⁺ and FDMA, DMF, NMP, and DMSO solvent.

FIG. 14A is a plot showing chronoamperometry curve of a Li∥PVHF-FDMA-SPE∥Li cell, and the inset shows the EIS spectra of the initial and stable state.

FIG. 14B is a plot showing chronoamperometry curve of a Li∥PVHF-DMF-SPE∥Li, and the inset shows the EIS spectra of the initial and stable state.

FIG. 15A is a plot showing TGA curves of PVHF-FDMA-SPE and PVHF-DMF-SPE.

FIG. 15B is a plot showing comparison of weight and molar ratio of residual solvents in PVHF-FDMA-SPE and previously reported typical VDF-based SPE (The colors of green, blue, and orange represent DMF, NMP, and FDMA solvents, respectively).

FIG. 16 is a set of images showing combustion tests for PVHF-FDMA-SPE and PVHF-DMF-SPE.

FIG. 17A is a plot showing Raman spectra of the PVHF-DMF-SPE.

FIG. 17B is a plot showing Raman spectra of LiTFSI.

FIG. 18A is a plot showing a coordination number of Li—O (TFSI⁻), Li—O (FDMA), and Li—F (PVHF).

FIG. 18B is a schematic diagram showing coordination structure of Li⁺ and FDMA, TFSI⁻ in PVHF-FDMA-SPE.

FIG. 19A is a plot showing cv curves for a Li∥PVHF-DMF-SPE∥SS Cell

FIG. 19B is a plot showing CV curves for a Li∥PVHF-FDMA-SPE∥SS cell.

FIG. 20A is a plot showing EIS of the cycled Li∥PVHF-FDMA-SPE∥Li symmetric cell.

FIG. 20B is a blot showing a cyclic voltammetry (CV) curves of the cycled Li∥PVHF-FDMA-SPE∥Li symmetric cell.

FIG. 21A is a plot showing critical current density of the Li∥PVHF-FDMA-SPE∥Li and Li∥PVHF-DMF-SPE∥Li cell.

FIG. 21B is a plot showing voltage profiles of lithium plating/stripping in Li∥PVHF-FDMA-SPE∥Li cell with current density from 0.1 to 1 mA cm⁻².

FIG. 21C is a plot showing voltage profiles of lithium plating/stripping in Li∥PVHF-FDMA-SPE∥Li cell with current density of 1 mA cm⁻².

FIG. 22 is a set of images showing optical photographs of 20 μm Li anode after different cycles in Li∥PVHF-FDMA-SPE∥Li cell.

FIG. 23 is a plot showing the Li deposition-stripping profiles of Li∥PVHF-DMF-SPE∥CU cell.

FIG. 24 is a plot showing plating profile of Li in Li∥PVHF-FDMA-SPE∥Cu cell, inset shows the SEM and optical images of deposited Li on Cu foil.

FIG. 25 is a plot showing the TOF-SIMS depth profiles for C₂HO⁻, LiCO₃⁻, LiF₂⁻, LiN₃F⁻, and LiSF⁻ in the SEI layer.

FIG. 26 is a plot showing the exchange current density of PVHF-FDMA-SPE and PVHF-DMF-SPE.

FIG. 27A is a plot showing cycling performance of the Li∥PVHF-FDMA-SPE∥LFP cell under different temperatures and C rates.

FIG. 27B is a plot showing corresponding charge/discharge voltage profiles of the Li∥PVHF-FDMA-SPE∥LFP cell under different temperatures and C rates.

FIG. 28 is a plot showing charge and discharge voltage profiles of Li∥PVHF-FDMA-SPE∥LFP full cell after different cycles.

FIG. 29 is a plot showing EIS of Li∥PVHF-FDMA-SPE∥LFP cell with 20 μm Li anode before and after cycling.

FIG. 30A is a plot showing cycling performance of the Li∥PVHF-FDMA-SPE∥LFP with 20 μm Li metal and high LFP cathode mass loading of 15.6 mg cm⁻² at a current density of 0.1 mA cm⁻².

FIG. 30B is a plot showing corresponding charge/discharge voltage profiles of the Li∥PVHF-FDMA-SPE∥LFP with 20 μm Li metal and high LFP cathode mass loading of 15.6 mg cm⁻² at a current density of 0.1 mA cm⁻²after different cycles.

FIG. 30C is plot showing cycling performance of the Li∥PVHF-FDMA-SPE∥LFP and Li∥PVHF-DMF-SPE∥LFP cells with 20 μm Li metal anode and low LFP cathode mass loading of 3 mg cm⁻² at current density of 0.5 mA cm⁻².

FIG. 30D is a plot showing corresponding charge/discharge voltage profiles after different cycles of d Li∥PVHF-FDMA-SPE∥LFP cell

FIG. 30E is a plot showing corresponding charge/discharge voltage profiles after different cycles of Li∥PVHF-DMF-SPE∥LFP cell.

FIG. 31 is a plot showing charge/discharge voltage profiles of Li∥PVHF-FDMA-SPE∥LFP pouch cell after different cycles.

FIG. 32 is a set of image showing a fully-charged Li∥PVHF-FDMA-SPE∥LFP pouch battery powering a light-emitting diode under different folding or cutting conditions.

FIG. 33A is a plot showing cycling performance of the Li∥PVHF-FDMA-SPE∥LFP pouch cell, inset shows the optical photograph of the pouch cell.

FIG. 33B is a plot showing corresponding charge/discharge voltage profiles of the Li∥PVHF-FDMA-SPE∥LFP pouch cell under different current densities.

FIG. 34 is a plot LSV curves of PVHF-DMF-SPE and PVHF-FDMA-SPE at a scan rate of 1 mV s⁻¹.

FIG. 35 is a plot showing charge/discharge curves of Li∥PVHF-FDMA-SPE∥LCO under different C rate a, and after different cycles b.

FIG. 36A is a plot showing cycling and rate performances for Li∥PVHF-FDMA-SPE∥NCM811.

FIG. 36B is a plot showing corresponding charge/discharge voltage profiles for Li∥PVHF-FDMA-SPE∥NCM811 under different C rate.

FIG. 37A is a plot showing leakage current curves of Li∥PVHF-FDMA-SPE∥LCO cell upon the constant-voltage from 4.0-4.5 V.

FIG. 37B is a plot showing 3th CV curves of Li∥PVHF-FDMA-SPE∥LCO cells in the voltage range of 3.2-4.3 V and 3.2-4.48 V at a scanning rate of 0.05 mV s⁻¹.

FIG. 38 is a plot showing XPS spectra of LCO electrode after cycling.

FIG. 38B is an SEM image of cycled LCO cathode.

FIG. 38C is another SEM image of cycled LCO cathode

### DETAILED DISCLOSURE OF THE INVENTION

The inventors, through their experiments and trials, devised that a small amount of residual solvent exists in VDF-based SPEs, attributed to the strong interactions between Li salt and the solvent. The residual solvent combines with Li slats to form [Li(solvent)ₓ]⁺ solvation structures. These structures facilitate rapid ion transportation through coordination and incoordination of [Li(solvent)ₓ]⁺ with electronegative fluorine (F) atom along the polymer chains. Therefore, the configuration of “Li salt-polymer-trace residual solvent” in VDF-based SPE enables the high ionic conductivity of 10⁻⁴ S cm⁻¹ at room temperature.

Unlike the ion transport in conventional solid polymer electrolytes, residual solvents play a crucial role in the ion transport of VDF-based SPEs. However, they also induce several problems that have long been neglected. Commonly used solvents such as N, N-dimethylformamide (DMF), N-Methyl-2-pyrrolidone (NMP), and Dimethyl sulfoxide (DMSO) are inherently thermodynamic unstable with lithium metal. Their side reactions with lithium metal result in the progressive formation of a thickened interfacial corrosion layer on the lithium metal surface, leading to increased interfacial impedance. On the other hand, the constant consumption of residual solvents in VDF-based SPEs leads to a decrease in ionic conductivity and exacerbates battery polarization.

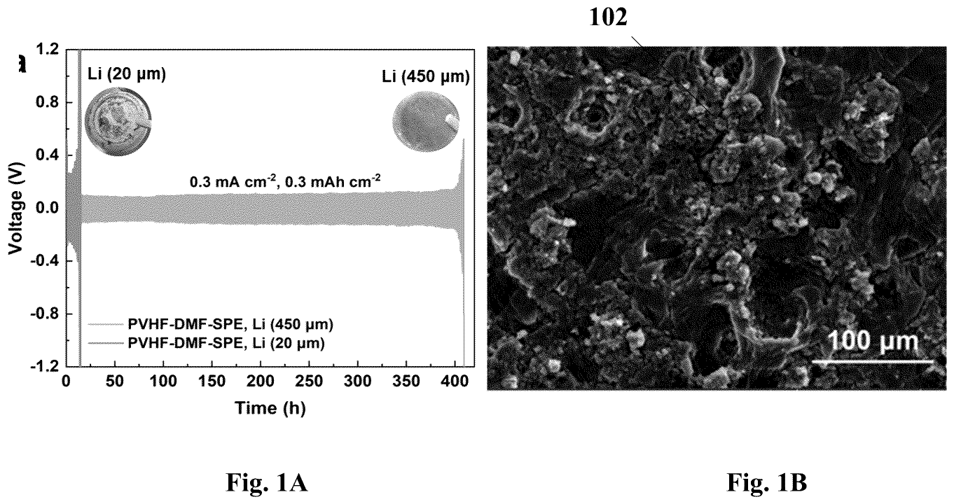

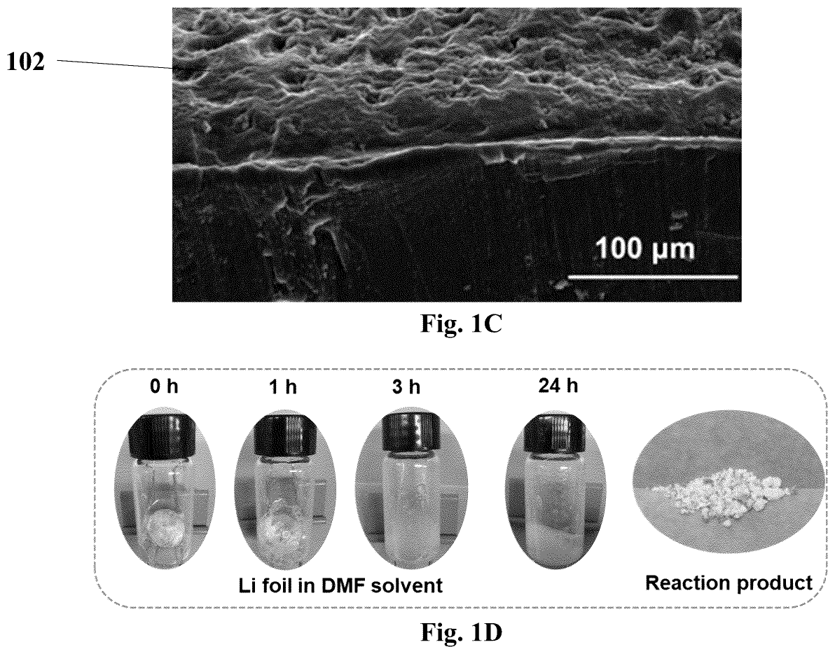

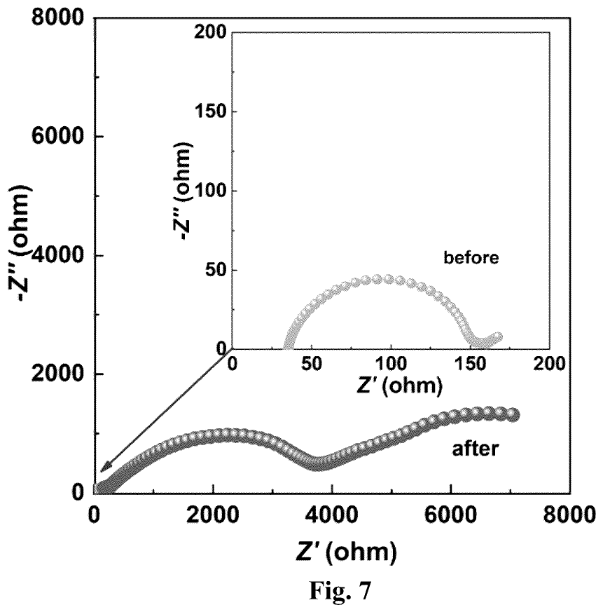

Incompatibility of conventional DMF solvent-contained PVHF-DMF-SPE with Li metal anode are explained referring to FIGS. 1A to 1D. With reference to FIG. 1A, a Li∥Li symmetric cell using PVHF-DMF-SPE may only cycle for 400 h even assembled with a 450 μm thick Li foil. Even worse, the cycling performance sharply declines to just 15 h when a 20 μm thick Li anode is used. This decline in cycling stability predominantly arises from side reactions between residual DMF and lithium metal, causing corrosion of Li 102 and accumulation of reaction by-products, further referring to FIGS. 1B and 1C, leading to an increased interfacial impedance referring to FIG. 7.

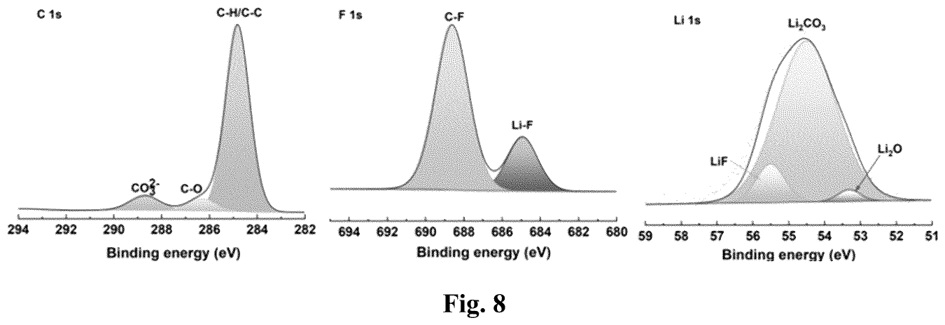

XPS spectra determined that carbonates constitute the primary chemical composition at the interphase as shown in FIG. 8. These chemical compositions are theoretically derived from the reaction products between DMF and Li metal or the decomposition of LiTFSI. The side reactions between DMF and Li metal were also directly observed when immersing a Li foil in DMF solvent, as indicated by the turbidity of the DMF solvent as shown in FIG. 1D, suggesting the intensive formation of by-products. These results emphasize the impracticality of using VDF-based SPEs containing residual DMF solvent in solid-state lithium metal batteries, especially when using ultra-thin lithium metal as the anode.

Some methods may be employed to balance ionic conductivity and interfacial compatibility. For example, this includes the introduction of inorganic fillers to anchor residual solvent molecules, adding organic additives and adjusting the type of Li salts to generate a solid electrolyte interface (SEI) protective layer on Li metal. Nevertheless, electrochemical instability during Li plating/stripping persists, particularly at high current densities and long-term cycling. Additionally, the inadequate antioxidation ability and continuous decomposition of residual solvents at high potential contribute to a narrow electrochemical stability window, diminishing compatibility with high-voltage cathodes. These interface issues caused by residual solvents have long been neglected, limiting the practical application of VDF-based SPEs in solid-state lithium metal batteries. Consequently, it is fundamentally and technologically crucial to pioneer an innovative solvent for VDF-based SPEs to address interface stability issues while preserving superior ion transport capabilities.

The inventors found that residual solvents in vinylidene fluoride (VDF)-based solid polymer electrolytes (SPEs) has high ionic conductivity. However, side reactions by the residual solvents with the lithium (Li) metal induce poor stability, which has been long neglected. In this invention, a delicate equilibrium between ion conduction and electrode stability for VDF-based SPEs is achieved. Preferably, 2,2,2-Trifluoro-N, N-dimethylacetamide (FDMA) is provided in a preferred embodiment of the present invention as the non-side reaction solvent for poly(vinylidene fluoride-co-hexafluoropropylene) (PVHF)-based SPEs, achieving both high ionic conductivity and significantly improved electrochemical stability.

The terminology used herein Is for the purpose of describing particular embodiments only and is not intended to be limiting to the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In a preferred embodiment of the present invention, there is provided a solid polymer electrolyte (SPE) for a rechargeable battery, comprising a polymer matrix including a vinylidene fluoride (VDF)-based compound and a residual solvent including a fluorinated solvent, wherein the residual solvent is arranged facilitate ion transportation of ions of a solvation complex of a metal in the rechargeable battery.

For example, the SPE may be used in a rechargeable battery such as a lithium battery including a metal anode and a cathode consisting of a metal compound usually included in lithium-ion battery, e.g. Li metal may be included as an anode and LiFePO₄ or LiCoO₂ may be included as cathode. the SPE physically separates the metal anode from the metal compound cathode, and also facilitate ion exchange between the anode and the cathode, utilizing the solvent retained by the SPE.

When the cell is charging, the lithium particles move from the cathode, through the structure of the atoms that form the separator, and then move in between the separator itself and the anode's electrical contact, thus forming a solid layer of pure lithium, and when the cell is discharging, lithium from the anode is “released” from the anode to the cathode through the SPE. As described earlier in this disclosure, residual solvent which facilitates ion exchange between the two electrodes plays an important role in the ion exchange process.

Preferably, the residual solvent is arranged to stabilize a solid electrolyte interface formed between an electrode material and the solid polymer electrolyte in the rechargeable battery, i.e. the residual solvent influences the interface stability between VDF-based SPE and electrodes. In preferred embodiments of the present invention, the polymer matrix containing the residual solvent includes poly(vinylidene fluoride-co-hexafluoropropylene) (PVHF).

The inventors, through their experiments and trials, devised that fluorinated solvent having a molecular structure including a —CF₃ group is more preferable to other solvents, in which the solid electrolyte interface (SEI) is stabilized by a protective barrier at the solid electrolyte interface, which will be further described later in this disclosure in more details.

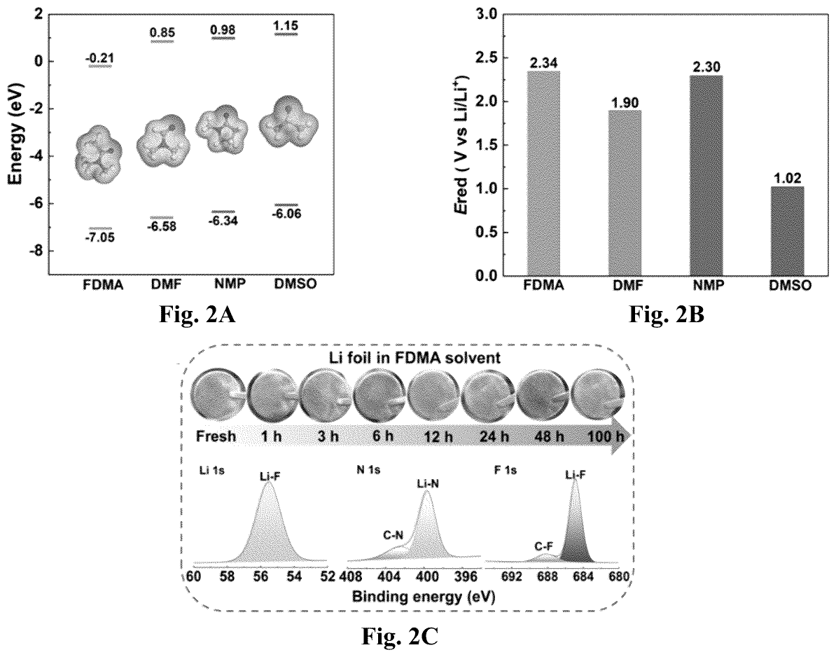

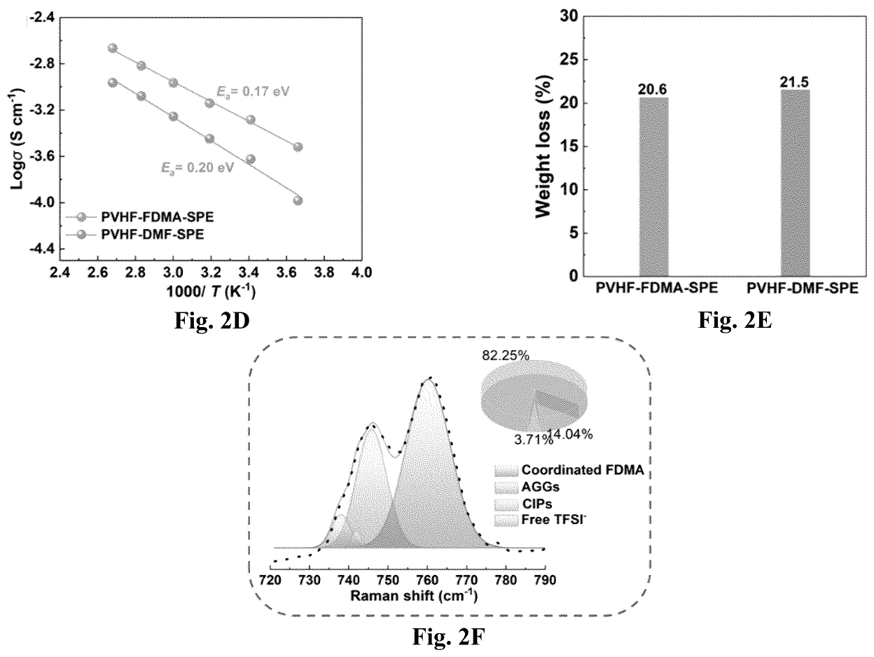

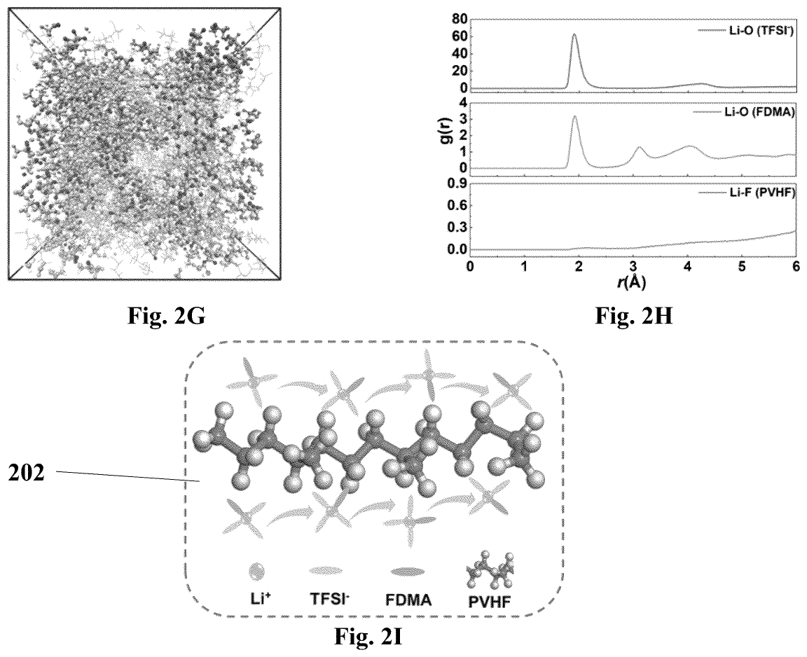

Preferably, the residual solvent includes fluorinated 2,2,2-Trifluoro-N, N-dimethylacetamide (FDMA). With reference to FIGS. 2A and 2B, the calculated lowest unoccupied molecular orbital (LUMO) and highest occupied molecular orbital (HOMO) energies, as well as the reduction potential of carefully selected solvent of FDMA and commonly used solvents, including N, N-Dimethylformamide (DMF), N-Methylpyrrolidone (NMP), Dimethyl sulfoxide (DMSO) for VDF-based SPEs are illustrated. Density functional theory (DFT) calculations were performed using the Gaussian16 program package with the B3LYP-D3 def2-TZVP basis set. Quantum chemical calculations of HOMO and LUMO energies were carried out using density functional theory. The binding energy (E_{b}) between solvent molecules with Li salt was defined as follows:

E_{b}=E_{Li}⁺−_{TFSI}⁻−ₛₒₗᵥₑₙₜ−E_{Li}⁺−_{TFSI}⁻−Eₛₒₗᵥₑₙₜ

where E_{Li} ⁺−_{TFSI}⁻−ₛₒₗᵥₑₙₜ, E_{Li}⁺−_{TFSI}⁻, and Eₛₒₗᵥₑₙₜ represent the energy of the Li⁺−TFSI⁻-solvent cluster, Li⁺−TFSI⁻ salt and solvent, respectively.

The adsorption energy of solvent on Li (110) surface was determined as follows:

E_{B}=E_{Li/solvent}−(E_{Li}+Eₛₒₗᵥₑₙₜ),

where E_{Li/solvent}, E_{Li} and Eₛₒₗᵥₑₙₜ represent the total energy of the Li surfaces containing the adsorbed solvent, the clean surface and the adsorbed solvent, respectively.

The reduction potentials (E_{red}) of the solvent were calculated based on the formula:

E_{red}=−(G_{red}−Gᵢₙᵢₜ+ΔG^{○}ₛₒₗᵥ(init))/F−1.4

where G_{red} and Gᵢₙᵢₜ are the free energies of the reduced and initial Li⁺-solvent complexes in gas-phase at 298.15 K, respectively. ΔG^{○}ₛₒₗᵥ(red) and ΔG^{○}ₛₒₗᵥ(init) are the corresponding free energies of solvation. F is the Faraday constant and the subtraction of 1.4 V accounts for the conversion to the Li/Li⁺ potential scale.

In Macromolecular Dynamic (MD) simulations, to simplify the calculation, 10 repeat segment units of (—CH₂CF₂—)ₓ[—CF₂CF(CF₃)—]_{y} (x: y =2:1) represented the PVHF chains. The model was constructed based on the TGA-measured mass ratio of 4:4:1 for PVHF:LiTFSI:FDMA (mass ratio). Thus, 14 PVHF with 5 repeat segment units in each chain, 209 LiTFSI, and 273 FDMA molecules were initially set up into a cube box with a side length of 20 nm by packmol software. The simulation process included energy minimization with the steepest descent algorithm, followed by 5 ns NVT and 20 ns NPT simulations to ensure equilibrium. In the NPT process, the system was heated to 698.15 K and 1 bar for 2 ns, then cooled to 298.15 K for 3 ns and maintained at this temperature for 15 ns, followed by an additional 50 ns NPT simulation at 298.15 K and 1 bar. All simulations were conducted with a time step of 1 fs.

With reference to FIGS. 2A to 2I, there is shown a set of experimental results of the solvent selection and characteristics of the PVHF-based polymer electrolytes. By comparison, DMSO exhibits the highest HOMO energy, suggesting poor oxidative stability. The amide solvents of DMF and NMP show intermediate HOMO energy levels. After introducing a strong electron —CF₃ group to the structure to form FDMA, it shows a decreased HOMO energy, suggesting improved oxidative stability towards high-voltage cathodes. Simultaneously, electrostatic potential (ESP) mapping (insets in FIG. 2A) illustrates the more uniformly distributed negative charge of FDMA solvent, characterized by lower polarity than other solvents, leading to reduced interactions between FDMA and PVHF polymer chains.

In addition, the —CF₃ group may further facilitate uniform dispersion of FDMA within PVHF and to facilitate establishment of continuous ion transport channels. Such weak polarity facilitates uniform solvent dispersion within PVHF, thereby establishing continuous ion transport channels and resulting in high ionic conductivity.

Testing samples fabricated according to preferred embodiments of the present invention were used for evaluating the improved SPE comprising a polymer matrix and a solvent of vinylidene fluoride (VDF)-based compound. Materials being used in the experiment includes bis(trifluoromethane)sulfonimide lithium salt (LiTFSI, ≥99.9%), anhydrous N, N-Dimethylformamide (DMF, >99.9), N-Methyl-2-pyrrolidone (NMP >99.9), and Dimethyl sulfoxide (DMSO >99.9), 2,2,2-trifluoro-N, N-dimethylacetamide (FDMA, 95%), and Poly(vinylidene fluoride-co-hexafluoropropylene) (PVHF, average Mw ˜455,000), LiFePO₄ (LFP), LiCoO₂ (LCO), and LiNi_{0.8}Co_{0.1}Mn_{0.1}O₂ (NCM811) powders, Super P, polyvinylidene fluoride (PVDF), Li foils (20 or 450 μm).

In preparation of solid-state electrolytes, PVHF-HFP polymer matrix and LiTFSI salt were added into FDMA solvent with a mass ratio of 1:1. The resulting homogenized slurry was then poured into a PTFE disk and dried in an Ar-filled glovebox at 55° C. for 12 h. The resulting polymer electrolyte membrane was labeled as PVHF-FDMA-SPE. For comparison, PVHF-DMF-SPE was prepared using the same steps with DMF as the solvent.

X-ray photoelectron spectroscopy (XPS) spectra were conducted in Thermo K-Alpha XPS spectrometer equipped with a monochromatic Al-Kα X-ray source. The morphologies were analyzed by Field-emission scanning electron microscope (FESEM; Verios 5UC). The time-of-flight secondary ion mass spectrometry (TOF-SIMS) was detected by PHI NanoTOFII with a negative mode. AFM-nano-infrared examinations were carried out using a Bruker Dimension Edge instrument. Raman spectra were obtained with a HORIBA JY LabRAM (532 nm). Thermogravimetry analysis measurements spanning 40° C. to 500° C. with a heat rate of 10° C. min⁻¹ were performed under a N₂ atmosphere using a Q50 thermogravimetric analyser.

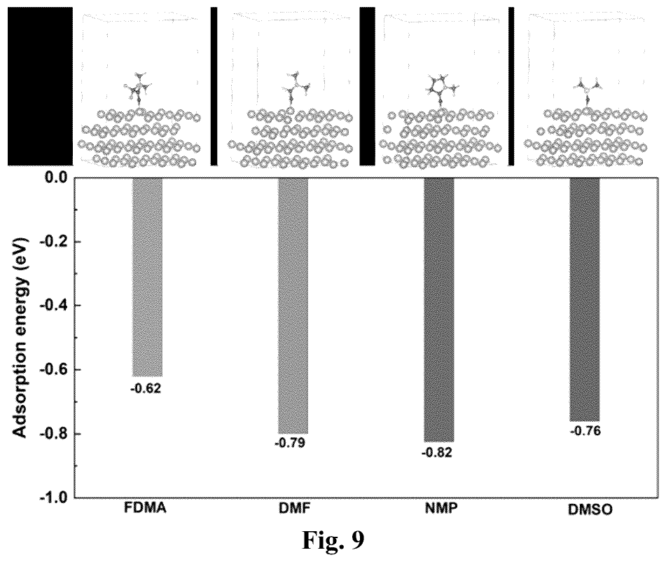

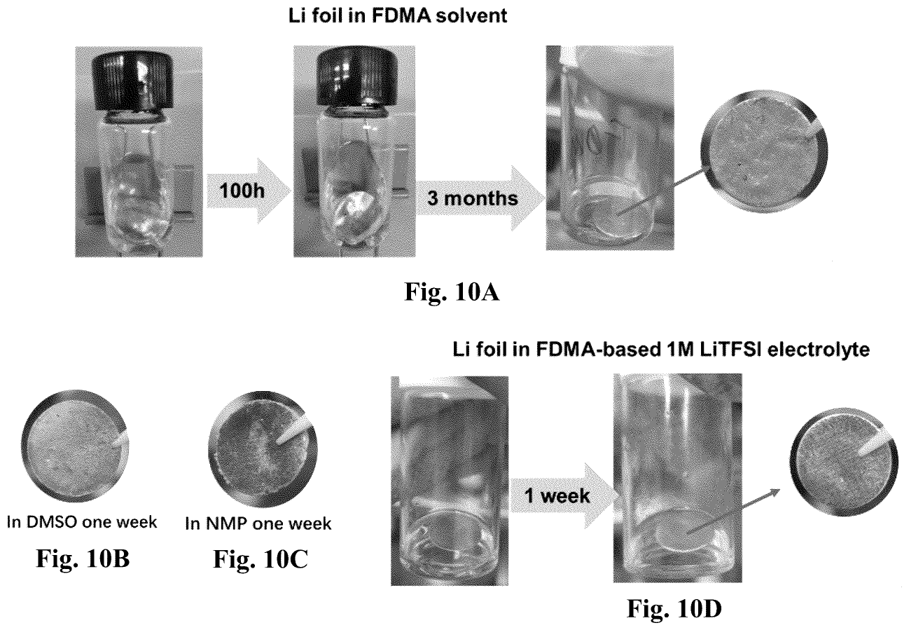

With reference also to FIG. 9, it is shown that the lowest adsorption energy of FDMA on the Li surface, confirming the interface stability with Li metal. Notably, as depicted in FIG. 2C, the Li metal immersed in FDMA solvent maintains a bright color for over 100 h. It retains its metallic color after three months as shown in FIG. 10A. However, Li foils immersed in DMSO and NMP solvents demonstrated varying degrees of corrosion after one week as shown in FIGS. 10B and 10C. In contrast, Li metal immersed in FDMA-based 1M LiTFSI electrolyte for one week remains stable as shown in FIG. 10D, highlighting superior compatibility between FDMA and Li metal. XPS investigations illustrate the formation of a LiF and Li—N compounds-rich interface layer on Li metal, resulting from spontaneous reactions between FDMA solvent and Li metal. The in-situ formed interface layer or protective battier prevents continuous corrosion of Li metal by solvents, ensuring interface stability.

Preferably, PVHF-based SPE includes FDMA being the solvent component. Meanwhile, it is observed that PVHF-FDMA-SPE exhibits a uniform and dense structure with excellent flexibility with reference to FIG. 11. The tensile test shows the mechanical characteristics of the PVHF-FDMA-SPE membrane referring to FIG. 12. The PVHF-FDMA-SPE exhibits a tensile strength of 6.9 MPa and a strain at a break of 149%, marginally surpassing those of the PVHF-DMF-SPE. This suggests commendable mechanical integrity and substantial promise for special applications, such as flexible batteries.

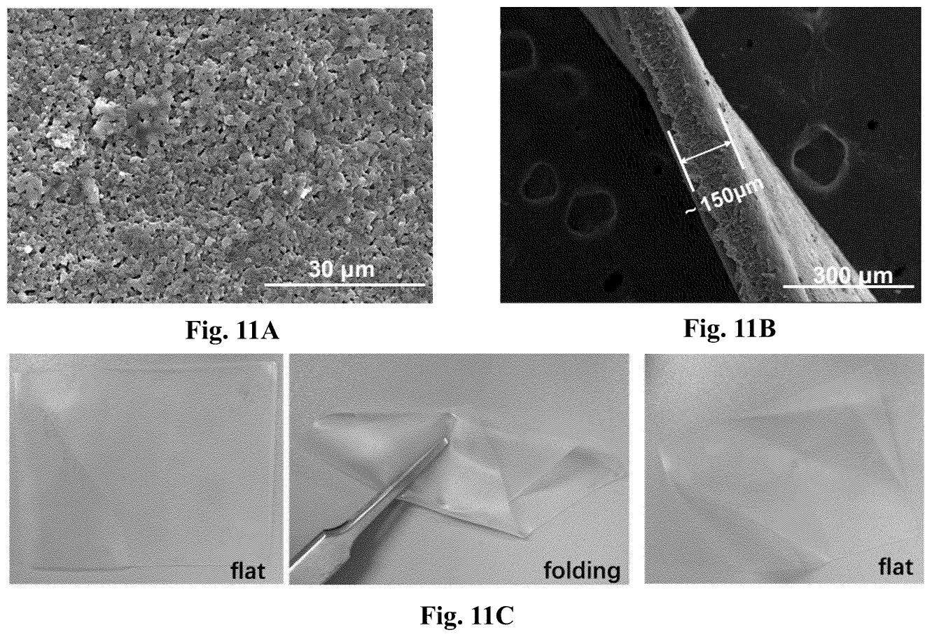

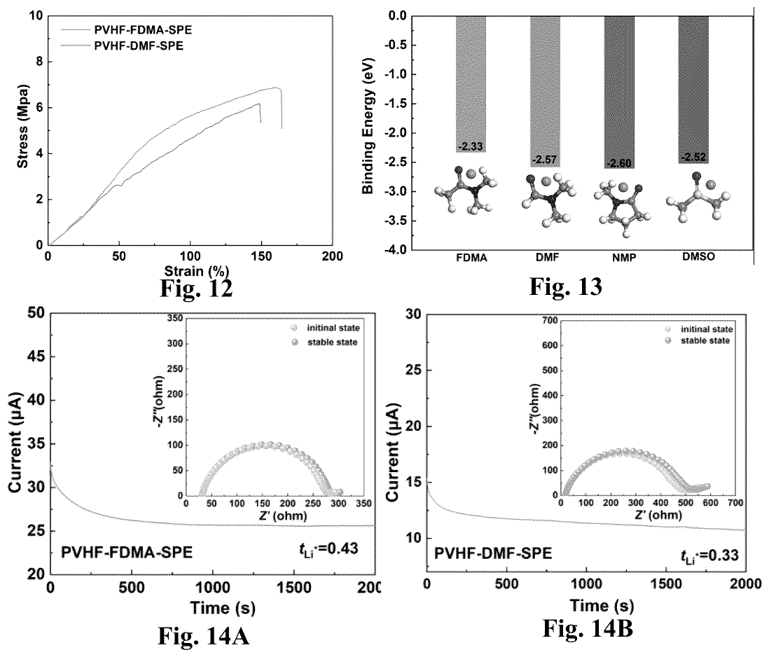

The ionic conductivities of PVHF-FDMA-SPE and PVHF-DMF-SPE were calculated through electrochemical impedance spectroscopy (EIS) measurements. As depicted in FIG. 2D, PVHF-FDMA-SPE exhibits a higher ionic conductivity (5.2×10⁻⁴ S cm⁻¹) at 25° C. than PVHF-DMF-SPE (2.4×10⁻⁴ S cm⁻¹). Moreover, the activation energy (Eₐ), calculated from the Arrhenius plots of ion migration in PVHF-FDMA-SPE, is 0.17 eV, lower than that in PVHF-DMF-SPE (0.20 eV), indicating a lower migration barrier for Li⁺ in PVHF-FDMA-SPE. The higher ionic conductivity and lower Eₐ of PVHF-FDMA-SPE are mainly attributed to the lower solvation energy between FDMA and Li⁺ with reference to FIG. 13. A high Li⁺ transference number (t_{Li}⁺=0.43) for PVHF-FDMA-SPE was obtained, which is higher than that of PVHF-DMF-SPE (t_{Li}⁺=0.33) with reference to FIG. 14.

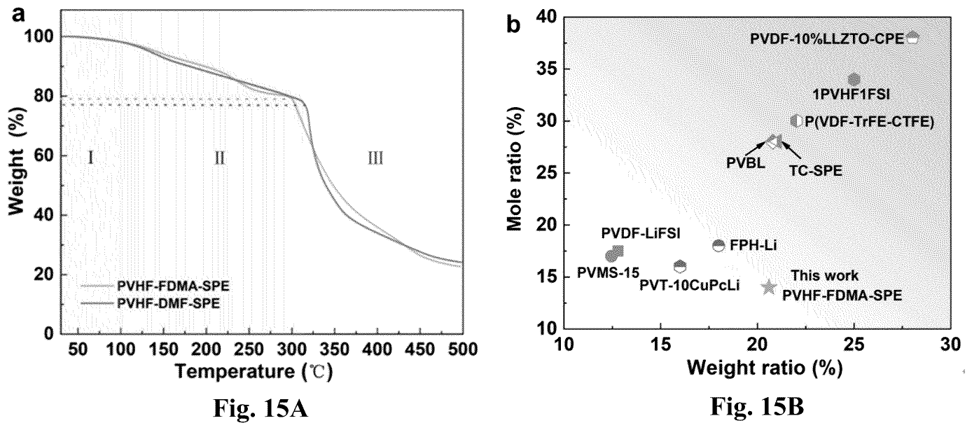

Additionally, with reference to FIG. 15, thermogravimetric analysis (TGA) was performed to detect solvent residues in SPEs. The minor weight loss before 100° C. (region I) comes from the evaporation of the trapped moisture, and the weight loss between 100° C. and 320° C. is ascribed to the residual solvent (region II), the weight loss between over 320° C. is ascribed to the decomposition of LiTFSI and PVHF (region III).

The thermogravimetry analysis (TGA) measurements, as shown in FIG. 15A, reveal that the weight content of residual solvent for PVHF-FDMA-SPE and PVHF-DMF-SPE is 20.6 wt. % and 21.5 wt. % as shown in FIG. 2E, respectively.

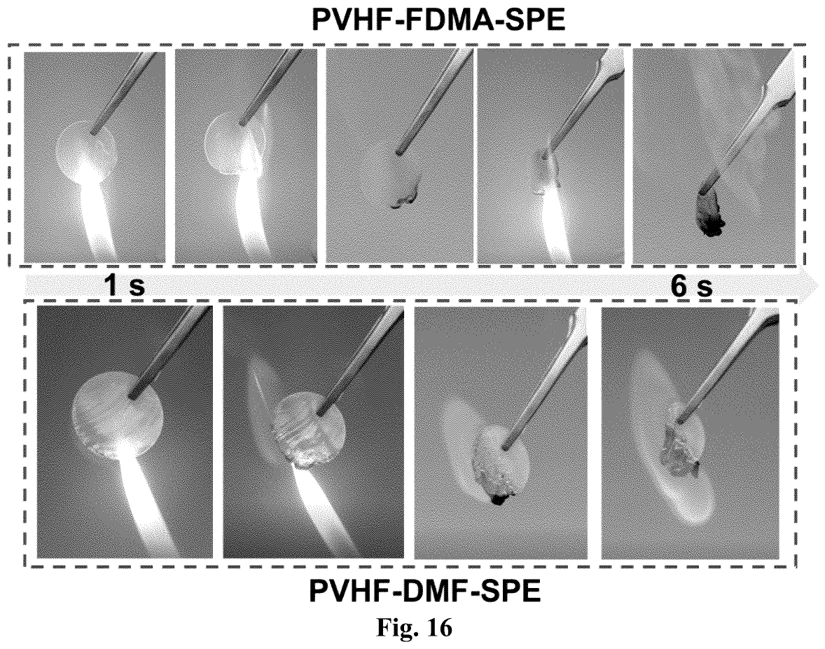

The corresponding mole ratio of residual solvent in PVHF-FDMA-SPE is only 14%, significantly lower than that of a VDF-based SPE as shown in FIG. 15B. Combustion tests of PVHF-FDMA-SPE and PVHF-DMF-SPE were conducted, with reference to FIG. 16, PVHF-FDMA-SPE exhibited thorough nonflammability, while PVHF-DMF-SPE was ignited and burned continuously, even after removing the flame. Advantageously, the nonflammability of the PVHF-FDMA-SPE is attributed to the flame-retardant FDMA solvent.

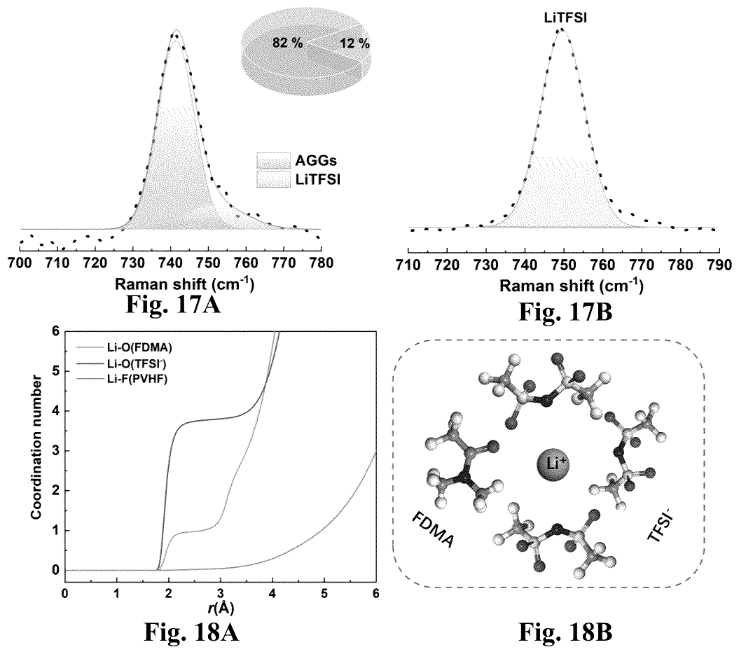

Furthermore, Raman tests were conducted to examine the Li⁺ coordination state with FDMA solvent and TFSI⁻ anions in PVHF-FDMA-SPE. As shown in FIG. 2F, the peak at around 759 cm⁻¹ is related to the Li⁺-coordinated FDMA. Meanwhile, the bands within the region of 725-750 cm⁻¹ were associated with the characteristic vibration of TFSI⁻, which could be further divided into three vibration bands at 738, 742, and 746 cm⁻¹ ascribed to free TFSI (Free TFSI⁻), contact ion pairs (CIPs), and aggregate clusters (AGGs) from coordinated TFSI⁻anions, respectively. The fitted amount of Free TFSI⁻, CIPs, and AGGs in PVHF-FDMA-SPE is 14.04%, 3.71%, and 82.25%, respectively. In contrast, only two peaks corresponding to AGGs and undissolved LiTFSI salt were observed in Raman spectra of PVHF-DMF-SPE with reference to FIG. 17, with the corresponding calculated amounts being 82% and 12%, respectively. Therefore, the higher free TFSI⁻and CIPs concentrations indicate more movable Li⁺ in the PVHF-FDMA-SPE.

To further understand the influence of the FDMA solvent on the ion transport mechanism of the PVHF-FDMA-SPE 202, molecular dynamics (MD) simulations were carried out to investigate the coordination structures referring to FIGS. 2G and 2H. The strong peaks of the Li-O pairs at 1.93 Å indicated that both the FDMA and TFSI⁻ were coordinated with Li⁺. The coordination number between Li⁺and FDMA is 1; for Li⁺ and TFSI⁻, the number is 3 referring to FIG. 18. Notably, there is no coordination between the F atom of PVHF and Li⁺. Therefore, Li-ion transport in PVHF-FDMA-SPE 202 mainly relies on combining residual FDMA solvent and Li salts to form a Li-FDMA-3TFSI⁻ solvation structure. Its intermolecular interactions with the PVHF chain could transport this structure, facilitating ion conduction. The Li-FDMA-3TFSI⁻ solvation structure transport mechanism in PVHF-FDMA-SPE 202 is illustrated in FIG. 2I.

The inventors also performed Electrochemical measurements for evaluating the electrical performance of by fabricating testing coin cells comprising the SPE in accordance with embodiments of the present invention. All the electrochemical performances of the polymer electrolytes were measured by a CHI 760D electrochemical workstation. The ionic conductivity was determined through electrochemical impedance spectroscopy (EIS) employing a stainless steel (SS)∥SS coin cell. Measurements were conducted in the temperature range of 0 to 100° C., with a frequency ranging from 1 MHz to 0.1 Hz and an AC amplitude of 10 mV. The ionic conductivity of the polymer electrolytes was calculated using the following equation:

□=L/R⋅S

where L presents the thickness of the SPE membrane, R represents the bulk ohmic resistance, and S symbolizes the contact area between SS and the polymer electrolyte membrane.

The lithium-ion transference number (t_{Li}⁺) of the SPEs was examined by combining AC impedance and DC polarization methods using a symmetrical Li cell. The value of t_{Li}⁺ is calculated according to the Bruce-Vincent-Evans equation:

t_{Li}⁺=I_{S} Rb_{S}(ΔV−I₀R₀)//₀Rb₀(ΔV−I_{S}R_{S})

where ΔV is the applied DC polarization voltage of 10 mV; I₀ and I_{S} present the direct current before and after polarization; and R₀ and R_{S} stand for the initial and final charge-transfer resistance of the polarization process; and Rb₀ and Rb_{S} are the initial and final resistances of the polymer electrolytes, respectively.

The activation energy Eₐ for the Li⁺ conduction was calculated according to the Arrhenius equation:

σ=A exp(−Eₐ/k_{b}T)

Where A is the pre-exponential factor, k_{b} presents the Boltzmann constant, T is the absolute temperature, and Eₐ is the activation energy.

The electrochemical stability window of the polymer electrolyte was investigated through cyclic voltammetry (CV) and linear sweep voltammetry (LSV) measurements, measured on the SS∥Li unsymmetrical cell at a scan rate of 1 mV s⁻¹.

The battery comprising the SPE in accordance with embodiments of the present invention may be fabricated as follows. The cathodes were prepared using a traditional slurry-coating method. In this process, cathode materials (LFP, LCO, or NCM811), super P, and PVDF were wetly mixed in the NMP solvent with a weight ratio of 8:1:1. The resulting slurry mixture was cast onto a carbon-coated Al foil and dried at 80° C. for 8 h in a vacuum. The cathode was then obtained with an active material mass loading of 2.5-3 mg cm⁻². For the LFP cathode with a high mass loading, LFP, super P, PVDF, and LiTFSI were used with a mass ratio of 8:1:1:1. The cathode was cut into 12 mm diameter disks for the CR2032 type coin cell. For the Li∥LFP pouch cells, cathode sheets with a high areal capacity of about 1.0 mAh cm⁻² (LFP mass loading 6.5-7 mg cm⁻²) were selected to pair with 20 μm thick Li—Cu composite foil. All the coin cells and pouch cells were assembled in an argon-filled glovebox with H₂O <0.1 ppm and O₂ <0.1 ppm. The galvanostatic charge/discharge performances and electrochemical properties were recorded by the LAND CT2001A testing system and CHI 760D electrochemical workstation, respectively.

The cyclic voltammetry (CV) curves in FIG. 19 indicate that PVHF-FDMA-SPE exhibits superior anode stability compared to PVHF-DMF-SPE. This suggests excellent interface stability between PVHF-FDMA-SPE and the Li metal anode. To delve deeper into the stability of PVHF-FDMA-SPE with Li metal anodes, the voltage variation of symmetric Li∥Li cells with different thicknesses of Li metal during galvanostatic cycling at various current densities were evaluated.

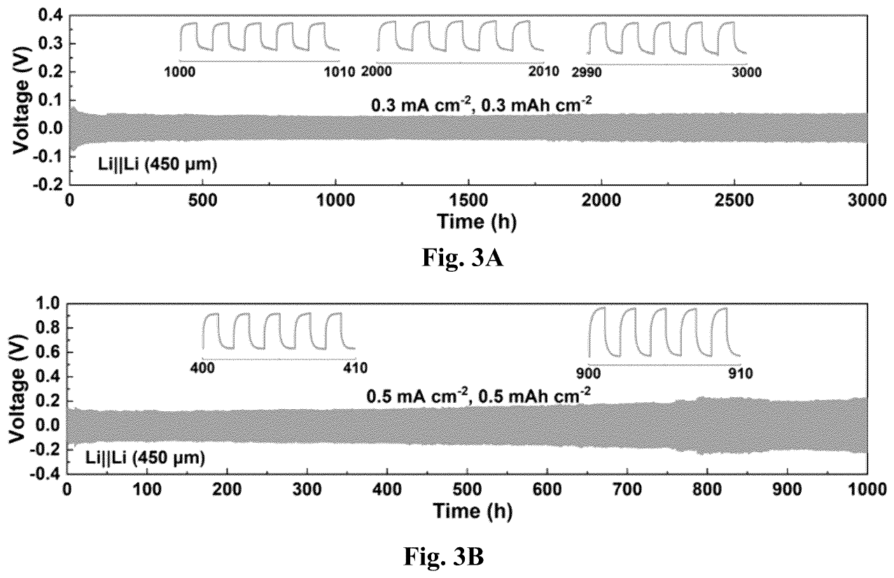

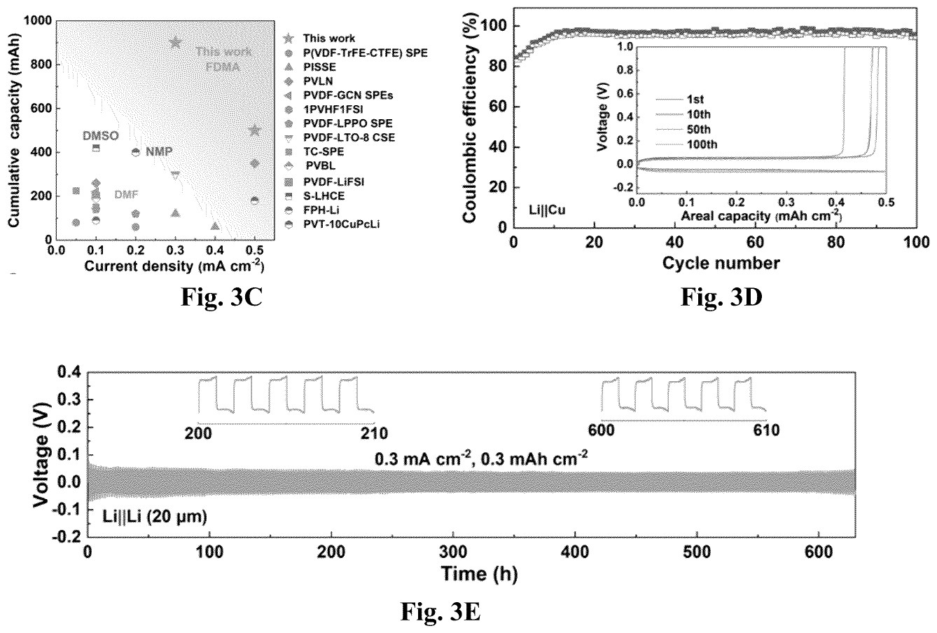

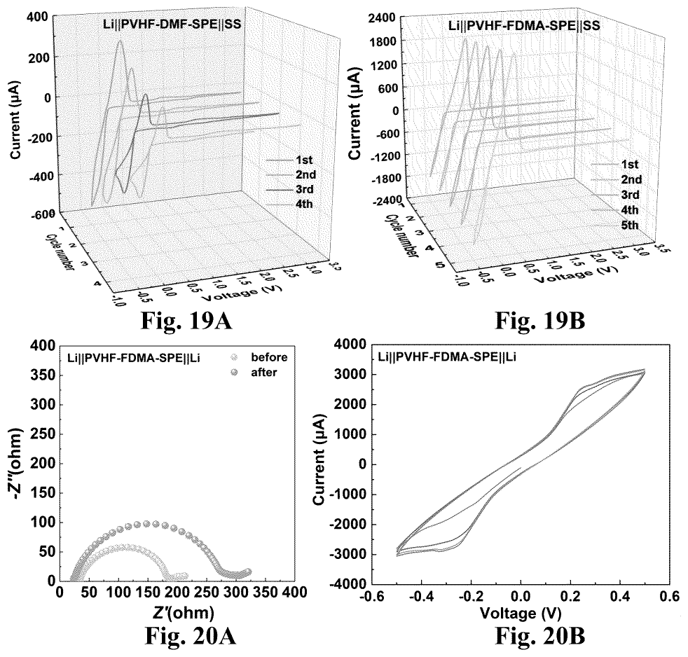

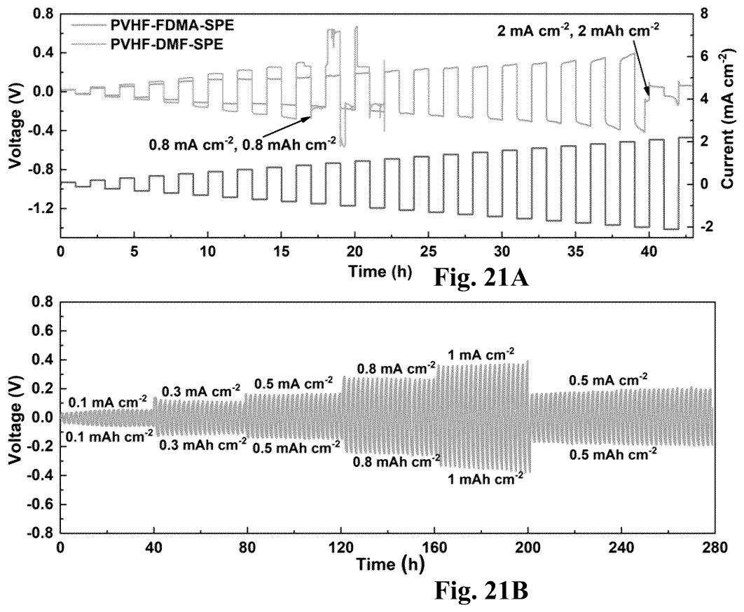

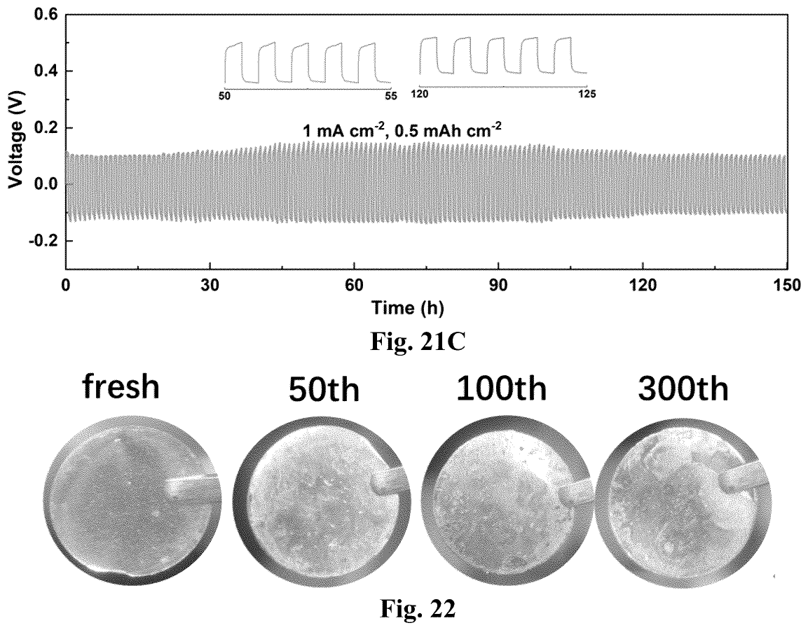

Now with reference to FIG. 3, there is shown evaluation results of Li-metal plating/stripping reversibility. As shown in FIG. 3A, the Li∥PVHF-FDMA-SPE∥Li symmetric cell exhibits stable cycling performance for over 3000 hours (>4 months) under a current density of 0.3 mA cm⁻². Additionally, electrochemical impedance spectroscopy (EIS) and cyclic voltammetry (CV) measurements as shown in FIG. 20 indicate the absence of a “soft short” circuit in the cell after prolonged cycling. As shown in FIG. 21A, the Li∥PVHF-FDMA-SPE∥Li cell has critical current densities (CCDs) of 2 mA cm⁻², which is much higher than that of the Li∥PVHF-DMF-SPE∥Li cell (0.8 mA cm⁻²). Meanwhile, the Li∥PVHF-FDMA-SPE∥Li symmetric cell can undergo tests at various current densities ranging from 0.1 to 1 mA cm⁻² as shown in FIG. 21, and stably cycle for 150 h at a high current density of 1 mA cm⁻² as shown in FIG. 21, demonstrating excellent lithium dendrite suppression capabilities at high current density.

Furthermore, with reference to FIG. 3B, even under the demanding conditions of a high current density of 0.5 mA cm⁻² with a capacity of 0.5 mAh cm⁻², no significant voltage polarization or short-circuiting was observed over a long cycling time of 1000 h. The cumulative plating/stripping capacity at 0.3 and 0.5 mA cm⁻² is 900 and 500 mAh cm⁻², respectively, significantly higher than other VDF-based SPEs using other solvents as shown in FIG. 3C.

Preferably, as shown in FIG. 3D, the Li∥Li cell can also stably cycle for over 600 h, even when a 20 μm ultrathin Li foil is used. The different voltage polarization behaviors compared with FIG. 2A may be caused by different interface impedances. The optical photographs display that the thin Li metal anode still maintains a bright color after different cycles as shown in FIG. 22. These results underscore the superb electrochemical stability of PVHF-FDMA-SPE 202 in the presence of a limited Li metal anode. The high Coulombic efficiency (CE) of the Li∥Cu cell is pivotal for constructing highly efficient solid lithium metal batteries. The Li∥PVHF-FDMA-SPE∥Cu half cells assembled with PVHF-FDMA-SPE 202 were also cycled at a current density of 0.3 mA cm⁻² with a lithiation capacity of 0.5 mAh cm⁻².

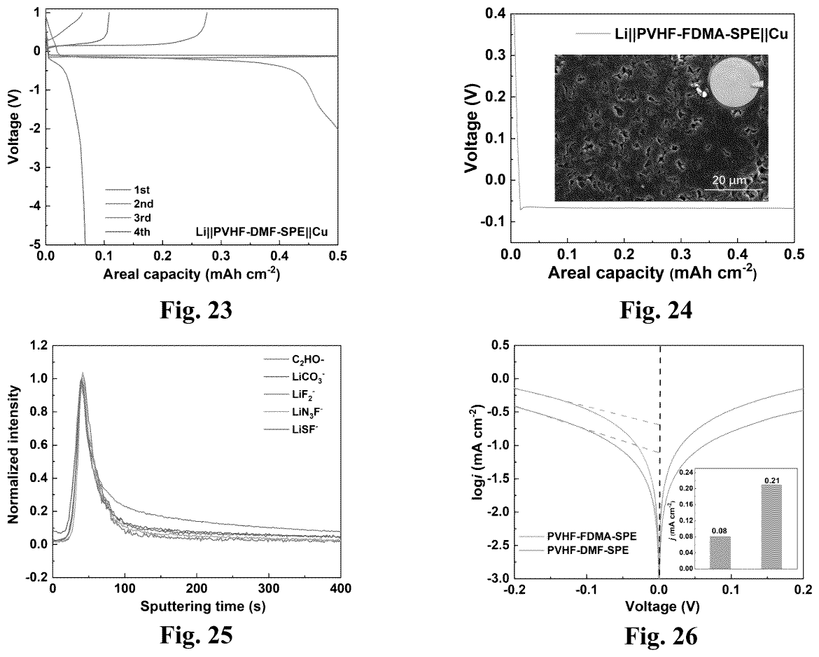

With reference to FIG. 3E, the Li∥PVHF-FDMA-SPE∥Cu cell gradually increased CE with continuous deposition/dissolution of Li, reaching 96% during the 15th to 100th cycles. The lower CE than typical Cu∥Li cells with liquid electrolytes is mainly attributed to the poor solid-solid interfacial contact between the PVHF-FDMA-SPE and Cu foil. Simultaneously, the voltage polarization of the Li∥PVHF-FDMA-SPE∥Cu cell remained stable over the 100 cycles as shown in inset in FIG. 3E, while the Li∥PVHF-DMF-SPE∥Cu cell showed a sharp increase in polarization within a few cycles as shown in FIG. 23. Meanwhile, the deposited Li on Cu foil in Li∥PVHF-DMF-SPE∥Cu cell exhibits a dense and smooth surface with non-dendritic Li referring to FIG. 24. The exceptional cycling stability and uniform lithium deposition of the Li∥PVHF-FDMA-SPE∥Cu cell is primarily attributed to the stable interface between PVHF-FDMA-SPE and the Li metal anode.

Preferably, the protective barrier of the solid electrolyte interface includes a predominant component of LiF, and may facilitate suppression of dendrite formation at the anode and/or corrosion of the anode. As appreciated by a skilled person in the art, other fluorinated solvent may be used for fabricating the SPE, for further development of the barrier containing the LiF component to form at the SEI.

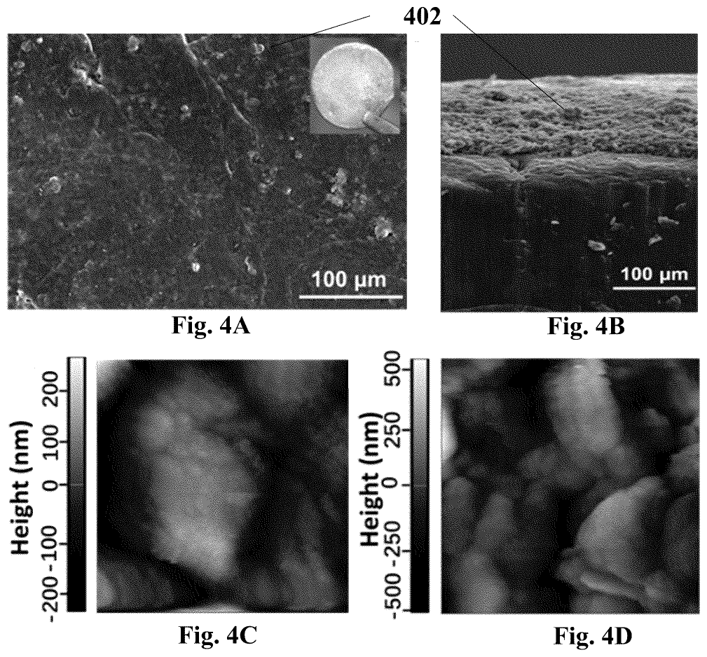

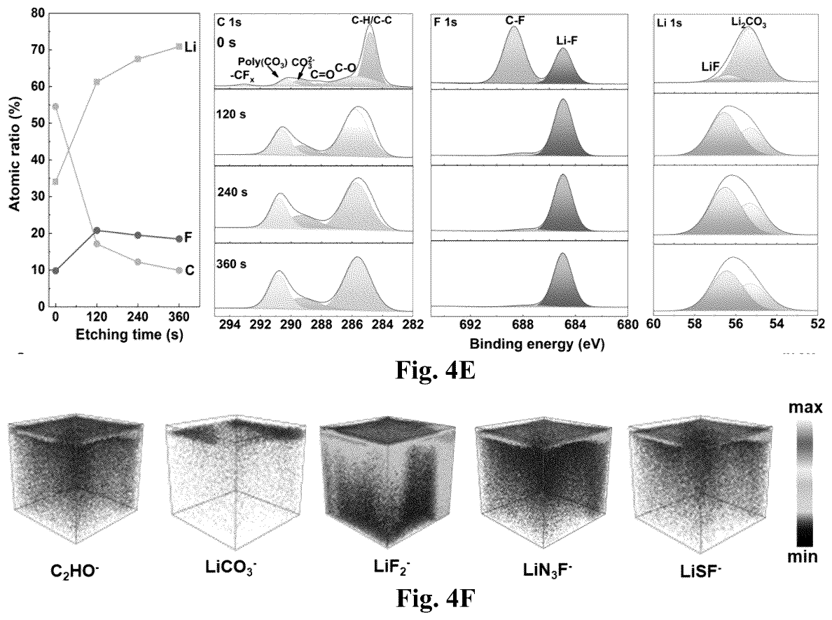

To evaluate interfacial stability and microstructural evolution of the PVHF-FDMA-SPE/Li interface, postmortem analyses were performed on cycled Li metal anodes obtained from the Li∥PVHF-FDMA-SPE∥Li cell after 100 cycles at 0.5 mA cm⁻² and 0.5 mAh cm⁻². The morphologies of the cycled Li metal were observed using scanning electron microscopy (SEM). Physicochemical characterizations of the SEI of cycled Li metal anode are shown in FIGS. 4A to 4F.

As shown in FIGS. 4A and 4B, the cycled Li anode exhibits uniform and compact surface structures and a dense deposition layer. Furthermore, the roughness of the Li surface was also studied by atomic force microscopy (AFM). The pristine Li metal surface 402 appeared smooth with a roughness of approximately 40 nm with reference to FIG. 4C. The roughness of the cycled Li metal only exhibited an increase to about 93 nm referring to FIG. 4D.

Advantageously, this smooth and compact surface suggests reduced internal corrosion and improved interfacial stability of PVHF-FDMA-SPE against the Li metal anode. X-ray photoelectron spectroscopy (XPS) depth profiling was carried out to determine the chemical composition of the solid electrolyte interphase (SEI) on cycled Li metal. The elements and their corresponding atomic ratios detected in the SEI layer, along with the C 1s, F 1s, and Li 1s spectra, are presented in FIG. 4E, respectively. The top surface of the SEI layer is composed of both organic (—CFₓ, Poly(CO₃), —C═O, C—O) and inorganic (LiF, Li₂CO₃) components. This relates to the decomposition of the TFSI⁻anions and FDMA solvent. As the etching depth increases, the organic signals gradually diminish.

At the same time, LiF persists and gradually becomes the predominant component of the SEI, suggesting that the external SEI of the Li metal is primarily organic, and inorganic LiF components dominate the internal SEI. Time-of-flight secondary ion mass spectroscopy (ToF-SIMS) measurements were conducted to provide additional information about the composition of the SEI. As shown in FIG. 4F and FIG. 25, fewer C₂HO⁻ and LiCO₃⁻ species are observed on the SEI surface, while LiF₂⁻, LiN₃F⁻, and LiSF⁻ species uniformly cover the Li anode, dominating the SEI composition.

Advantageously, this fluoride-dominated SEI derived from the PVHF-FDMA-SPE differs from DMF-derived SEIs that exhibit a Li₂CO₃-dominant structure. Therefore, the PVHF-FDMA-SPE shows a higher exchange current density of 0.21 mA cm⁻² compared to that of PVHF-DMF-SPE as shown in FIG. 26, indicating enhanced ion transport kinetics of the fluoride-dominated SEI.

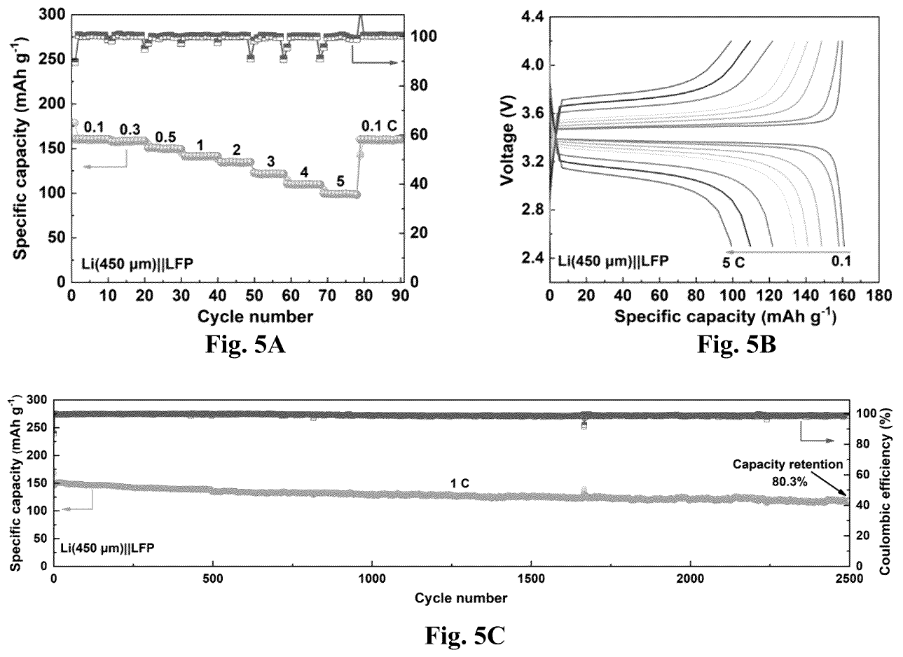

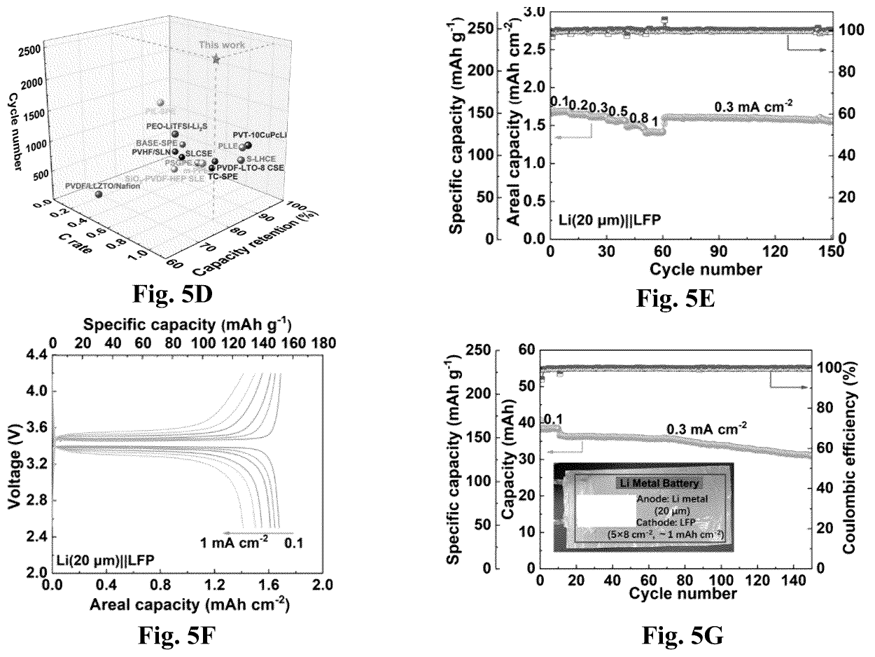

Referring to FIGS. 5A to 5G, to further demonstrate the effects of enhanced interface stability on battery performances, comprehensive tests on Li∥LiFePO₄ (LFP) full cells under various operation conditions were conducted in the experiment by the inventors. With reference to FIG. 5A, the rate performance of Li∥LFP cells assembled with PVHF-FDMA-SPE has been evaluated. Notably, high capacities ranging from 160.1 to 99.3 mAh g⁻¹ were achieved at C rates (1 C=170 mA g⁻¹) ranging from 0.1 C to 5 C. Upon returning to 0.1 C, the specific capacity rebounded to 159.3 mAh g⁻¹, demonstrating good capacity retention.

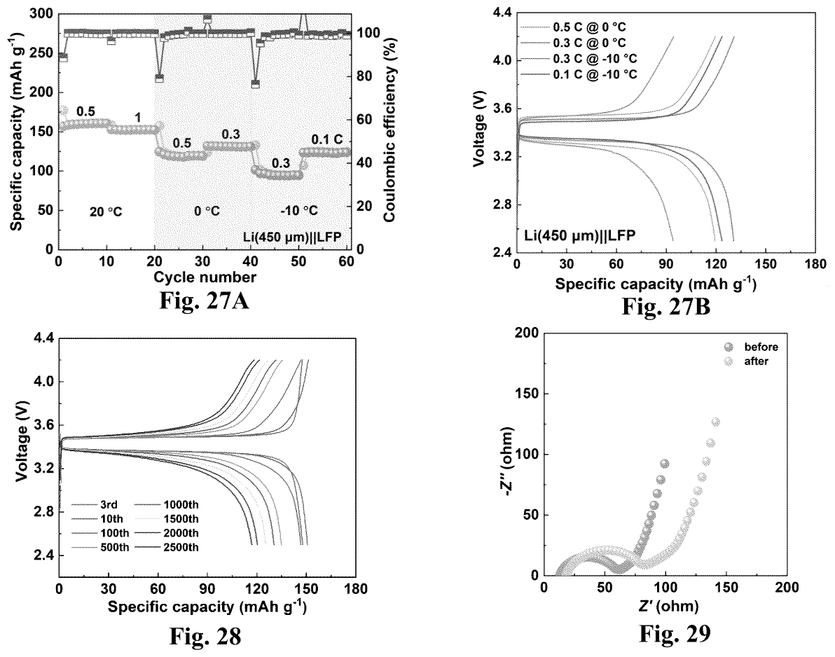

FIG. 5B illustrates the corresponding charge/discharge voltage profiles, indicating a stable voltage plateau without significant polarization. This is attributed to the high ionic conductivity and improved interface stability with PVHF-FDMA-SPE. In addition, benefiting from the high ionic conductivity and low ion transport activation energy of PVHF-FDMA-SPE, the Li∥PVHF-FDMA-SPE∥LFP cell achieves a high discharge capacity of 124.7 mAh g⁻¹ even at −10° C., with reference also to FIG. 27.

Moreover, as shown in FIG. 5C and FIG. 28, the Li∥PVHF-FDMA-SPE∥LFP cell exhibited outstanding cyclic performance, retaining 80.3% of its initial capacity even after 2500 cycles at 1 C. This ultralong lifespan and high-capacity retention outperform the majority of solid-state batteries utilizing VDF-based SPEs prepared with other solvents and other SPEs, as illustrated in FIG. 5D. The outstanding cycling performance can be attributed to the high interface stability and dendrite-free feature of the PVHF-FDMA-SPE against Li anodes of the SEI formed between the lithium anode and the PVHF-FDMA-SPE.

Preferably, with the improved SPE, i.e. PVHF-FDMA-SPE, the layer of lithium in the battery may be thinner or equal to 20 μm. The cycling performances of Li∥LFP cells with a restricted Li thick were evaluated, where the Li-metal thickness on the Cu current collector is 20 μm (areal capacity about 4 mAh cm⁻²), and the mass loading of LFP cathode material is 11.15 mg cm⁻² (Negative/Positive=2.1). Under these demanding conditions, the Li∥LFP coin cell demonstrated superior rate performance and stable cycling behavior, as depicted in FIGS. 5E and 5F. The Li∥LFP cell delivered areal capacities of 1.68, 1.64, 1.61, 1.55, 1.50, and 1.41 mAh cm⁻², corresponding specific capacities of 151.4, 147.8, 144.8, 139.3, 134.6, and 126.6 mAh g⁻¹, at current densities of 0.1, 0.2, 0.3, 0.5, 0.8 and 1 mA cm⁻², respectively. This cell exhibits a low overpotential even at 1 mA cm⁻² and a small charge transfer resistance as shown in FIG. 28, after cycling test, highlighting the outstanding electrochemical stability of PVHF-FDMA-SPE under low N/P ratio and high current density conditions.

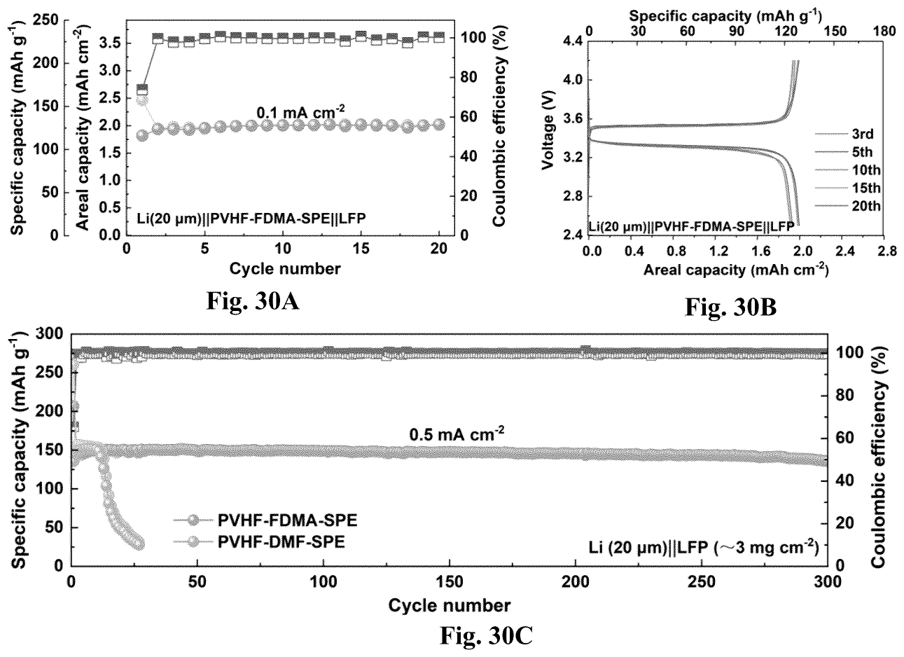

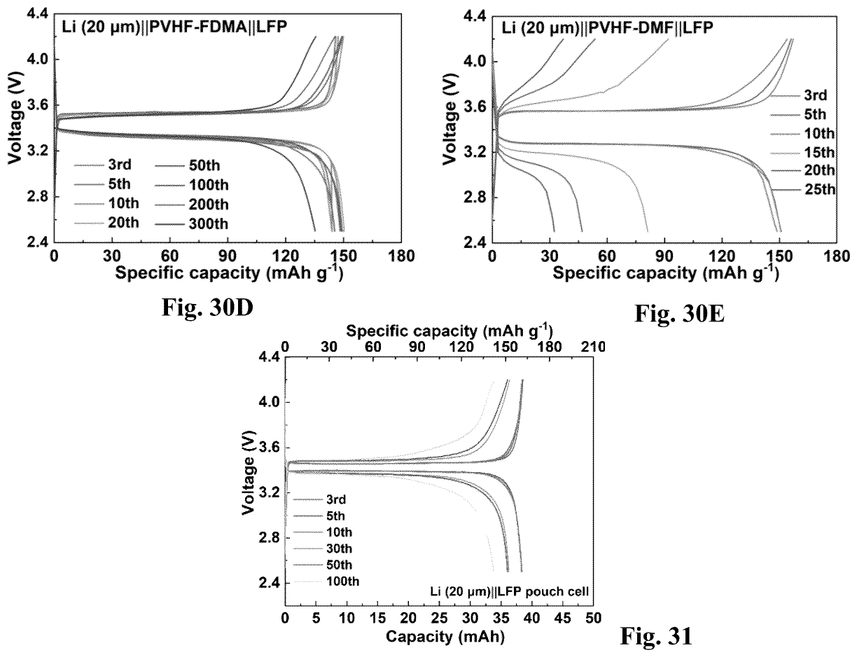

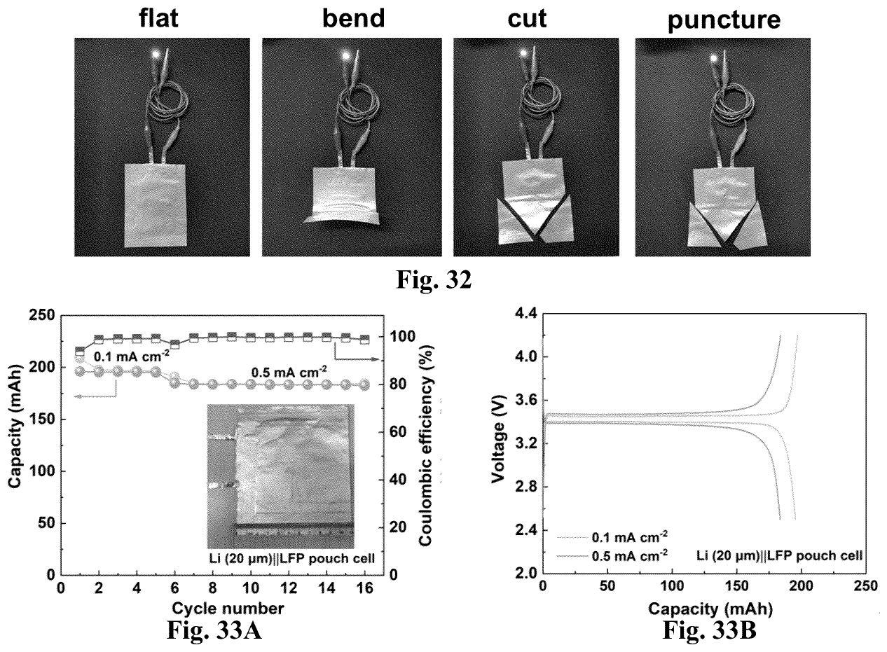

Meanwhile, the Li∥PVHF-FDMA-SPE∥LFP cells assembled with 20 μm Li metal can also stably operate with a higher LFP cathode mass loading of 15.6 mg cm⁻² (areal capacity of 2.6 mAh cm⁻²) as shown in FIGS. 30A and 30B, and lower LFP cathode mass loading of 3 mg cm⁻² (areal capacity of 0.5 mAh cm⁻²), while the Li∥PVHF-DMF-SPE∥LFP cell displays rapid capacity fade even with a low LFP cathode mass loading as shown in FIGS. 30C to 30E. As a further step, the pouch cell performance under harsh conditions, including a 20 μm Li metal anode and high areal cathode loading of about 1 mAh cm⁻², was systematically evaluated to emphasize the compatibility of PVHF-FDMA-SPE with Li metal anodes. As shown in FIG. 5G and FIG. 31, the pouch cell exhibited a practical capacity of 38.6 and 36.3 mAh (corresponding to specific capacities of 163 and 154 mAh g⁻¹) at current density of 0.1 and 0.3 mA cm⁻², respectively, with robust cyclability and an impressive 81.6% capacity retention after 150 cycles. This Li∥LFP pouch cell also demonstrated certain flexibility and excellent safety, which can stable work even under severe folding or cutting tests referring to FIG. 32. Moreover, a Li∥LFP pouch cell with a high capacity of about 200 mAh was fabricated. The cell shows practical capacities of 195 and 183 mAh at current densities of 0.1 and 0.5 mA cm⁻², with stable voltage plateaus as shown in FIG. 33, demonstrating its application potential.

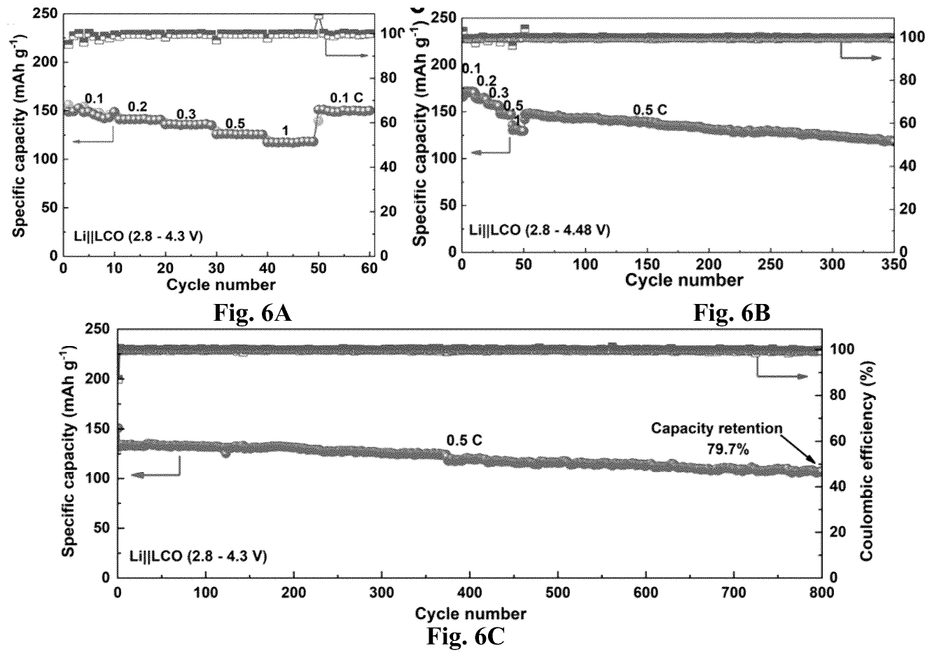

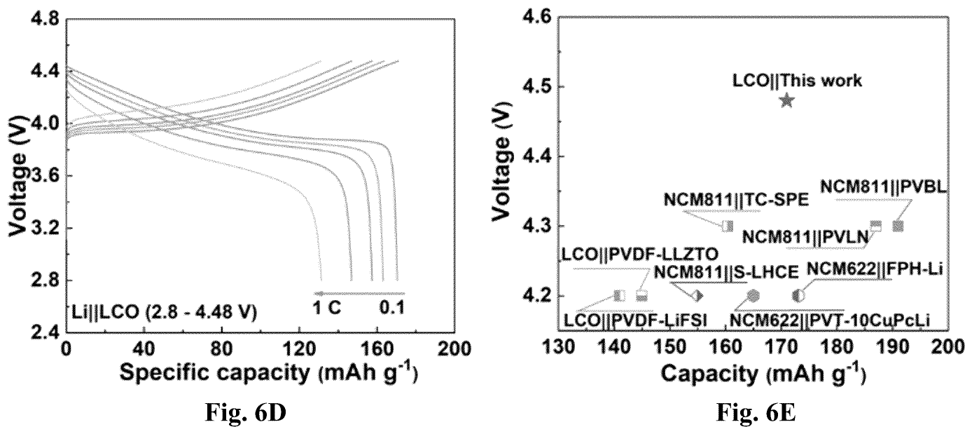

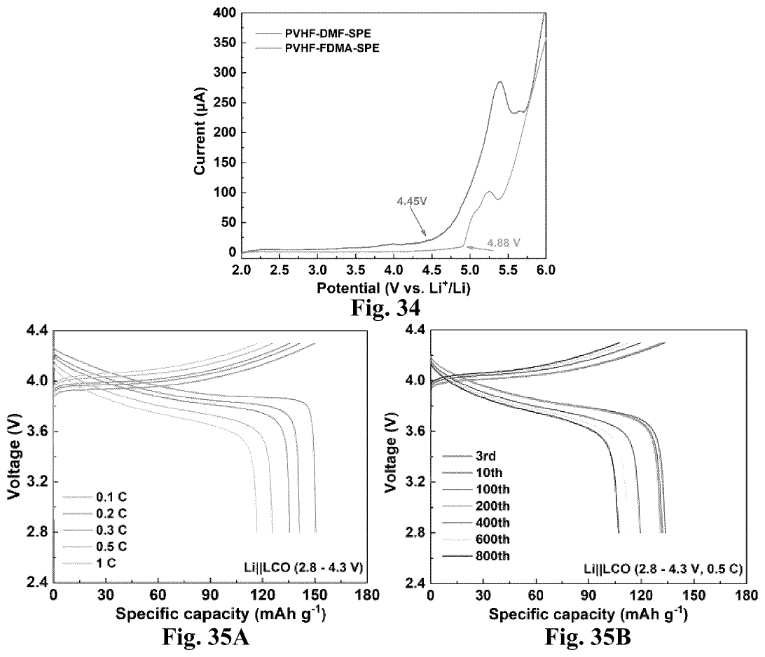

Preferably, the —CF₃ group of the fluorinated solvent may further improve an oxidative stability of cathode of the rechargeable battery. The PVHF-FDMA-SPE demonstrates an improved electrochemically stable voltage of up to 4.88 V compared to PVHF-DMF-SPE of 4.45V referring to FIG. 34, indicating its compatibility with high-voltage cathodes. The high oxidation and anodic stability offered by PVHF-FDMA-SPE can effectively prevent the continuous decomposition of residual solvent, thereby enabling the safe and durable operation of high-voltage Li metal batteries. Electrochemical performance of Li∥PVHF-FDMA-SPE∥LCO high voltage solid-state cells are further illustrated with reference to FIGS. 6A to 6E.

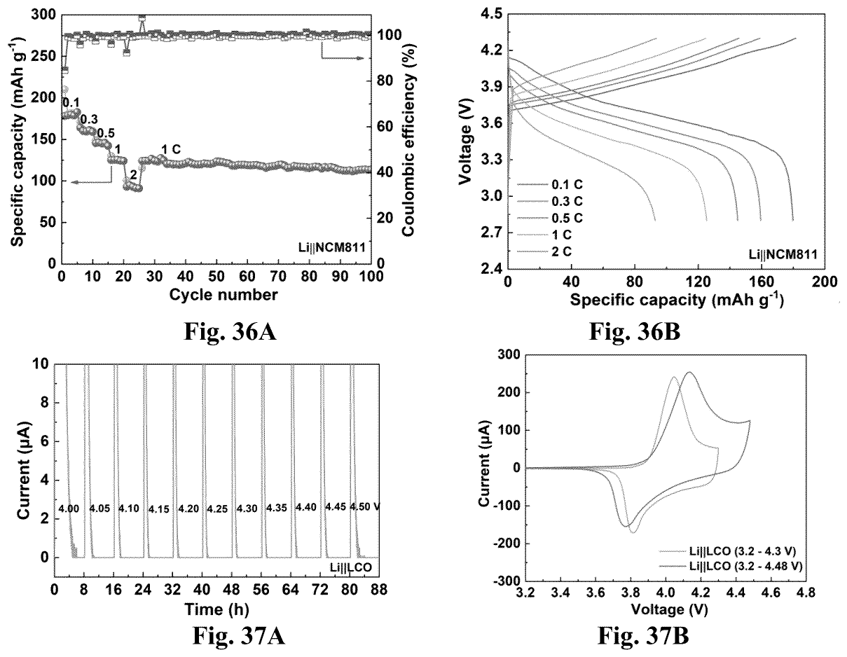

Referring to FIG. 6A, Li∥PVHF-FDMA-SPE∥LiCO₂ (LCO) full cell demonstrated excellent rate performance, delivering reversible capacities of 149.1, 141.4, 135.6, 125.9 and 117.2 mAh g⁻¹ for rates of 0.1, 0.2, 0.3, 0.5, and 1 C, respectively. The corresponding specific capacity-voltage curves also exhibited typical charge/discharge profiles within a current range of 2.8-4.3 V as shown in FIG. 35A. The low overpotential was attributed to the stable electrode/electrolyte interface and fast kinetics of Li⁺ transport. Referring to FIGS. 6B and 35B, the long-term cycling performance reveals that the Li∥LCO cell maintaining capacity retention of 80.5% after 800 cycles at 0.5 C, with average CE consistently exceeding 99.5%. In addition, the Li∥NCM811 cell exhibited high discharge capacity at different rate current densities and stable cycling performance within the operating testing voltage range of 2.5-4.3 V as shown in FIG. 36. These results confirm the broad applicability of PVHF-FDMA-SPE for commonly used 4.3 V-class cathodes.

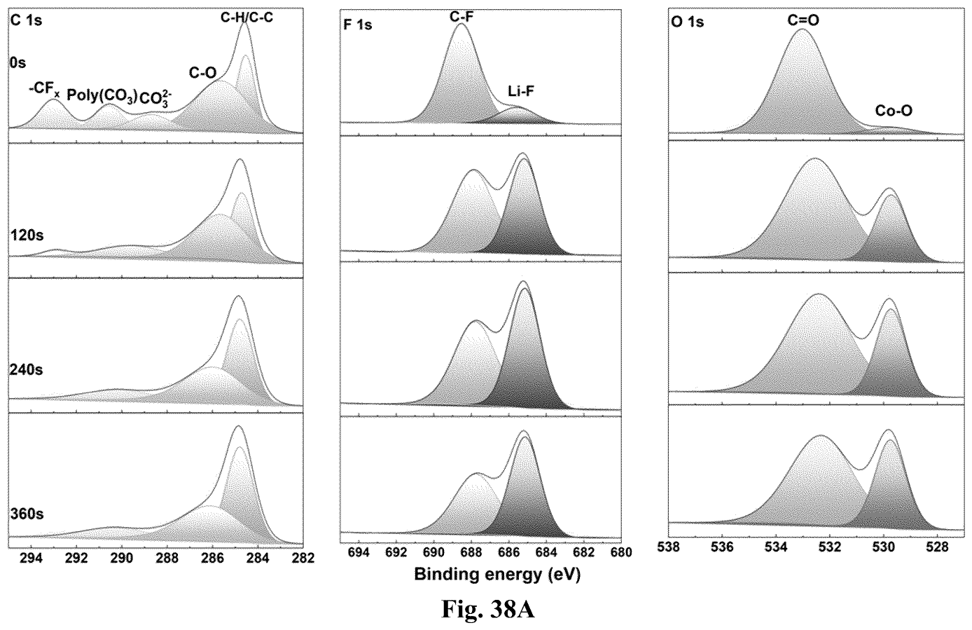

Furthermore, with reference to FIG. 37, the negligible leakage current of the Li∥LCO is maintained up to 4.5 V, and the superior redox reaction reversibility is extended up to 4.48 V. The changes of redox positions at a voltage range of 3.2-4.48 V are attributed to the formation of the cathode electrolyte phase (CEI) during the initial cycling process, leading to a slight irreversible phase transition in the LCO cathode, altering its reaction kinetics. This suggests that the excellent stability of PVHF-FDMA-SPE enables stable operation with LCO cathodes in a high voltage range. With reference to FIGS. 6C and 6D, within the operating testing voltage range of 2.8-4.48 V, the Li∥LCO cell delivered a high discharge capacity of 170.7, 163.2, 157.5, 147.1, and 131.3 mA h g⁻¹ at rates of 0.1, 0.2, 0.3, 0.5, and 1 C, respectively. Even after 350 cycles, the Li∥LCO still exhibited a capacity of 117.9 mA h g⁻¹ with a capacity retention of 79.7% from the 50th cycle at 0.5 C, demonstrating the advancements of PVHF-FDMA-SPE when matched with high-voltage cathodes.

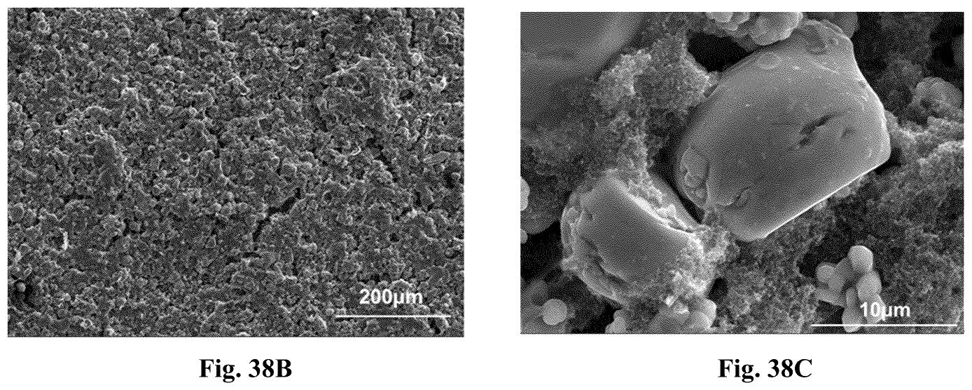

With reference FIG. 6E, the voltage-capacity performance of Li∥PVHF-FDMA-SPE∥LCO fabricated in accordance with embodiments of the present invention and other solid state lithium metal batteries based on various VDF-based SPEs and electrodes. The high voltage of PVHF-FDMA-SPE of the present invention outperforms other VDF-based SPEs using other solvents. Referring to FIG. 38A, the XPS spectra of cycled LCO cathodes implies that a LiF-rich cathode electrode interphase (CEI) layer was in-situ formed on the cathode, which contributes to the well-maintained smooth surface observed on the cycled LCO as shown in FIGS. 38B and 38C.

These embodiments may be advantageous in that, by using a fluorinated solvent, FDMA, for a PVHF-based SPE, the side interfacial reactions between the residual solvent and electrode in solid-state lithium battery may be suppressed. Incorporating residual FDMA solvent and LiTFSI salt results in [Li(FDMA)ₓ]⁺ solvation structure contributes to the ion transport in PVHF-FDMA-SPE. The SEI layer, generated through the reaction between FDMA and Li metal, acts as a protective barrier, contributes to a highly stable Li plating/stripping performance. This present invention provides a solution for achieving long-cycling and high-stability Li metal batteries.

Advantageously, the inherent stability of fluorinated FDMA solvent with Li metal ensures the interface stability between PVHF-FDMA-SPE and Li metal. The formed [Li(FDMA)ₓ]⁺ solvation molecules contributed to the high ionic conductivity with a low activation energy of the PVHF-FDMA-SPE. The developed FDMA solvent fosters the formation of a stable solid electrolyte interphase (SEI) through interface reactions with Li metal, effectively mitigating side reactions and dendrite growth on the Li metal electrode.

In addition, battery cells assembled using PVHF-FDMA-SPE exhibited significantly improved stabilities. Li∥Li cells achieved an impressive performance of 3000 h at 0.3 mA cm⁻² and 1000 h at 0.5 mA cm⁻². Li∥LiFePO₄ cells demonstrate excellent stability with 20 μm ultrathin Li metal anode and high-loading cathodes (>1 mAh cm⁻²). Moreover, the excellent antioxidant ability of FDMA endows the PVHF-FDMA-SPE with a wide electrochemical stability window, enabling the stable operation of a Li∥LiCoO₂ high-voltage cell up to 4.48 V. Moreover, the Li∥LFP cells assembled with PVHF-FDMA-SPE demonstrate excellent long-term cycling performance, even under limited Li (20 μm thick) supply and high-loading cathodes (>10 mg cm⁻², capacity >1 mAh cm⁻²) conditions.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A solid polymer electrolyte for a rechargeable battery, comprising a polymer matrix including a vinylidene fluoride (VDF)-based compound and a residual solvent including a fluorinated solvent, wherein the residual solvent is arranged facilitate ion transportation of ions of a solvation complex of a metal in the rechargeable battery.

2. The solid polymer electrolyte in accordance with claim 1, wherein the fluorinated solvent has a molecular structure including a —CF₃ group.

3. The solid polymer electrolyte in accordance with claim 2, wherein the residual solvent includes fluorinated 2,2,2-Trifluoro-N, N-dimethylacetamide (FDMA).

4. The solid polymer electrolyte in accordance with claim 3, wherein the metal includes lithium supplied from the anode of the rechargeable battery.

5. The solid polymer electrolyte in accordance with claim 4, wherein the rechargeable battery includes a lithium battery, and the solvation complex of the metal has a [Li(FDMA)ₓ]⁺ solvation structure.

6. The solid polymer electrolyte in accordance with claim 5, wherein the residual solvent is further arranged to stabilize a solid electrolyte interface formed between an electrode material and the solid polymer electrolyte in the rechargeable battery.

7. The solid polymer electrolyte in accordance with claim 6, wherein the solid electrolyte interface is stabilized by a protective barrier at the solid electrolyte interface.

8. The solid polymer electrolyte in accordance with claim 7, wherein the protective barrier of the solid electrolyte interface includes a predominant component of LiF.

9. The solid polymer electrolyte in accordance with claim 7, wherein the protective barrier is arranged to facilitate suppression of dendrite formation at the anode and/or corrosion of the anode.

10. The solid polymer electrolyte in accordance with claim 3, wherein the polymer matrix includes poly(vinylidene fluoride-co-hexafluoropropylene) (PVHF).

11. The solid polymer electrolyte in accordance with claim 10, wherein the —CF₃ group is arranged to improve an oxidative stability of cathode of the rechargeable battery.

12. The solid polymer electrolyte in accordance with claim 10, wherein the —CF₃ group is arranged to reduce interactions between FDMA and PVHF polymer chains.

13. The solid polymer electrolyte in accordance with claim 10, wherein the —CF₃ group is arranged to facilitate uniform dispersion of FDMA within PVHF and to facilitate establishment of continuous ion transport channels.

14. A rechargeable battery comprising: a layer of lithium arranged to operate as an anode of the rechargeable battery, a layer of lithium compound arranged to operate as a cathode of the rechargeable battery, and a polymer matrix between the anode and the cathode, the polymer matrix includes a vinylidene fluoride (VDF)-based compound and a residual solvent including a fluorinated solvent, wherein the polymer matrix is a solid polymer electrolyte, and the residual solvent is arranged facilitate ion transportation of ions of a solvation complex of lithium in the rechargeable battery.

15. The rechargeable battery in accordance with claim 14, wherein the residual solvent includes fluorinated 2,2,2-Trifluoro-N, N-dimethylacetamide (FDMA).

16. The rechargeable battery in accordance with claim 15, wherein the solvation complex of the metal has a [Li(FDMA)ₓ]⁺ solvation structure.

17. The rechargeable battery in accordance with claim 14, wherein the residual solvent is further arranged to stabilize by forming a protective barrier at a solid electrolyte interface formed between an electrode material and the solid polymer electrolyte in the rechargeable battery, wherein the protective barrier of the solid electrolyte interface includes a predominant component of LiF, and the protective barrier is arranged to facilitate suppression of dendrite formation at the anode and/or corrosion of the anode.

18. The rechargeable battery in accordance with claim 14, wherein the polymer matrix includes poly(vinylidene fluoride-co-hexafluoropropylene) (PVHF).

19. The rechargeable battery in accordance with claim 14, wherein the cathode includes LiFePO₄ or LiCoO₂.

20. The rechargeable battery in accordance with claim 14, wherein the layer of lithium is thinner or equal to 20 μm.
